(19) United States
(12) Patent Application Publication
(10) Pub. No.: US 2026/0163396 A1
(43) Pub. Date: Jun. 11, 2026

(54) CONTROL FRAMEWORKS FOR HYBRID ENERGY STORAGE AND MANAGEMENT

(71) Applicant: Joshua Paul Hitt, Redmond, WA (US)

(72) Inventor: Joshua Paul Hitt, Redmond, WA (US)

(21) Appl. No.: 19/401,103

(22) Filed: Nov. 25, 2025

Related U.S. Application Data
(60) Provisional application No. 63/728,542, filed on Dec. 5, 2024.

(51) Int. Cl. H02J 7/00; H02J 7/34

(52) U.S. Cl. CPC H02J 7/875; H02J 7/342; H02J 7/345; H02J 7/50; H02J 7/62; H02J 7/80; H02J 7/96; H02J 2207/10; H02J 2207/20; H02J 2207/50

(57) ABSTRACT

Described herein are improved hybrid energy storage devices and methods of using such devices as well as systems thereof.

### CROSS-REFERENCE TO RELATED APPLICATIONS

The present application claims the benefit of priority from U.S. Provisional Patent Application No. 63/728,542 , filed on Dec. 5, 2024, and entitled “METHODS OF USING A HYBRID ENERGY STORAGE DEVICE AND SYSTEMS THEREOF”, the entire disclosure of which application is hereby incorporated herein by reference.

### TECHNICAL FIELD

The present disclosure relates to hybrid energy storage devices and methods of using and managing such devices, as well as systems thereof. For example, the disclosure relates to control frameworks for hybrid energy storage and management.

### BACKGROUND

Energy storage systems frequently encounter challenges in delivering stable and reliable power outputs under varying conditions. Traditional batteries have fixed voltage profiles and power limitations, which may not be optimal for various applications.

Hybrid energy storage systems that combine multiple energy storage technologies are an alternative to standalone batteries. However, they can have complex power management requirements requiring highly engineered, custom designs that tend to be expensive, bulky, and difficult to scale.

Managing power supply and demand in various applications is a part of some energy storage systems. Existing systems often struggle with efficient power management, especially when multiple sources are connected, and can require manual control or intervention when determining how to route power.

Further, overcurrent situations in power electronics can damage components and reduce system efficiency with energy storage systems. Often, existing systems cannot sufficiently manage or adjust current limits to reduce the effects of such situations or are unable to adapt to the presence of complex conditions.

Also, in hybrid energy storage systems, it is important to manage charge levels and ensure the safe handling of components. Known systems often require manual intervention to manage charging and discharging processes, which can be inefficient and potentially hazardous.

### SUMMARY

In summary, the systems and methods (or techniques) disclosed herein can provide specific technical solutions to at least overcome the technical problems mentioned in the background section and other parts of the application, as well as other technical problems not described herein but recognized by those skilled in the art. In short, described herein are novel methods of using hybrid energy storage devices and novel systems thereof.

Some embodiments include an automated adaptive prioritization method for controlling power transfers in hybrid energy storage systems. Such systems can include one or more hybrid energy storage devices that utilize supercapacitors and batteries. Some examples include a method for prioritizing power transfers between multiple energy sources using a single bi-directional power converter using a control circuit.

Often, energy storage systems include management of power supply and demand. Existing systems often struggle with efficient power management when multiple sources are connected, and known technologies lack adaptive methods for prioritizing power transfers based on real-time parameters such as voltage, current, temperature, state-of-charge, source type, etc. To the contrary, in some embodiments, the systems or methods can include such adaptive methods.

Some examples include an automated and adaptive prioritization method that controls power transfers between two or more energy storage devices connected to a single bi-directional power converter. Such examples can include a method that dynamically adjusts priorities based on voltage levels, current limits, temperature readings, and other parameters, allowing for efficient energy management and enhanced system reliability.

Some embodiments include an energy storage system. For example, such embodiments can include a hybrid device that leverages supercapacitors. Also, some examples include a method for creating a firmware-controlled virtual voltage profile that can mimic battery voltage performance or generate custom voltage profiles adaptable to varying operational conditions.

Often, energy storage systems encounter challenges in delivering stable and reliable power outputs under varying conditions. Known batteries can have fixed voltage profiles and power limitations, which may not be optimal for many applications. As disclosed herein, some embodiments include the ability to create a dynamic and firmware-controlled voltage profile using supercapacitors that can enhance system performance and adaptability across various use cases and conditions.

Some examples include a method for employing supercapacitors to establish a firmware-controlled virtual voltage profile. Such a profile can simulate the voltage characteristics of various types of batteries or be customized to meet specific operational requirements based on real-time readings of voltage, current, or temperature.

Some embodiments include an automated source current limit correction in the energy storage system (such as a hybrid energy storage device or corresponding system). In some examples, for an energy storage system, such as hybrid devices that leverage supercapacitors and batteries, the system can provide an automated method for correcting source current limits in response to voltage fluctuations, enhancing system reliability and preventing future overcurrent and/or undervoltage conditions.

Sometimes, overcurrent situations in power electronics may damage components and reduce system efficiency. Existing systems often lack the capability to dynamically adjust current limits based on real-time voltage monitoring. Some of the systems described herein can provide an automated correction mechanism that can significantly improve the safety and performance of energy storage devices.

Some examples include a method for automated source current limit correction, wherein the controller logic can monitor voltage levels (such as continuously monitoring voltage levels). When a voltage drops below a predefined minimum threshold, the system automatically reduces the maximum allowable current or power output as well as the current ramp rate. This proactive approach helps prevent future overcurrent situations and enhances overall system stability.

Some embodiments include self-charging and self-discharging mechanisms for energy storage devices (such as for hybrid energy storage devices). For example, for energy storage devices, such as devices that leverage supercapacitors and batteries, the system can provide self-charging and self-discharging features that enhance user convenience and safety.

Often, with energy storage systems, such as hybrid systems, managing charge levels and ensuring the safe handling of components is crucial. Traditional systems often require manual intervention to manage charging and discharging processes, which can be inefficient and potentially hazardous. Some examples of the systems described herein can provide an automated approach to self-charging and self-discharging that can improve operational efficiency and user safety.

Some examples include a method for an energy storage device (such as a hybrid energy storage device) to automatically charge to a user-defined voltage or an external voltage measurement using a voltage probe. Additionally, the system or the device can include automated discharge mechanisms to either safely store energy in an internal battery or discharge supercapacitor energy through resistive elements. The system can also switch between operational modes, including an activation mode that wakes the device from sleep and charges the supercapacitors to a preset setpoint.

With respect to some embodiments, disclosed herein are computerized methods for using hybrid energy storage devices, as well as a non-transitory computer-readable storage medium for carrying out technical operations of the computerized methods. The non-transitory computer-readable storage medium has tangibly stored thereon, or tangibly encoded thereon, computer-readable instructions that, when executed by one or more devices (e.g., one or more personal computers or servers), cause at least one processor to perform a method of the system alone or in a computer network.

With respect to some embodiments, a system is provided that includes at least one computing device configured to provide a method for using a hybrid energy storage device. And, with respect to some embodiments, a method is provided to be performed by at least one computing device. In some example embodiments, computer program code can be executed by at least one processor of one or more computing devices to implement functionality in accordance with at least some embodiments described herein, and the computer program code being at least a part of or stored in a non-transitory computer-readable medium.

These and other important aspects of the invention are described more fully in the detailed description below. The invention is not limited to the particular assemblies, apparatuses, methods, and systems described herein. Other embodiments can be used and changes to the described embodiments can be made without departing from the scope of the claims that follow the detailed description.

### BRIEF DESCRIPTION OF THE DRAWINGS

The present disclosure will be understood more fully from the detailed description given below and from the accompanying drawings of various example embodiments of the disclosure. It is to be understood that the accompanying drawings presented are intended for the purpose of illustration and not intended to restrict the disclosure.

FIGS. 1 to 14 and FIG. 24 illustrate example methods, in accordance with some embodiments of the present disclosure.

FIGS. 15 to 20 and FIGS. 22 and 23 illustrate example electronic systems, in accordance with some embodiments of the present disclosure.

FIG. 21 illustrates a block diagram of example aspects of an example computer system, in accordance with some embodiments of the present disclosure.

### DETAILED DESCRIPTION

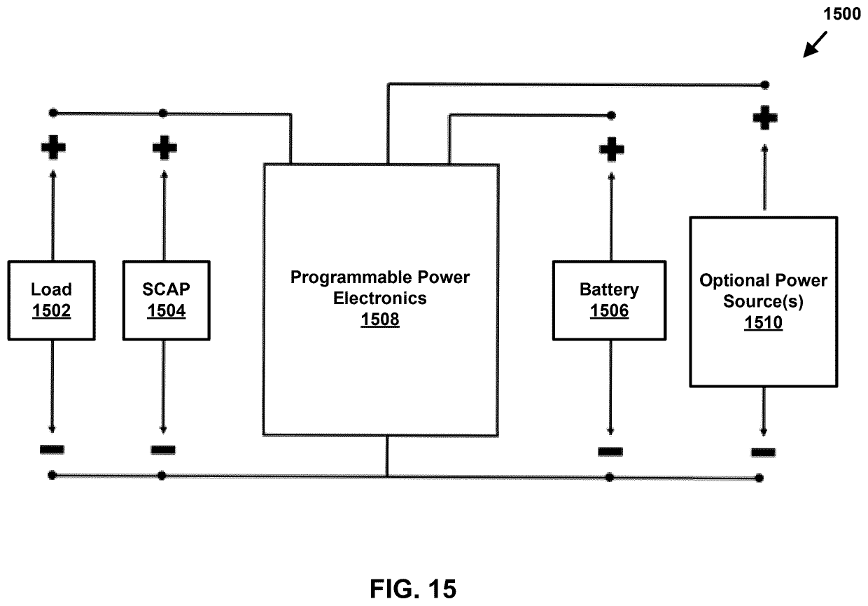

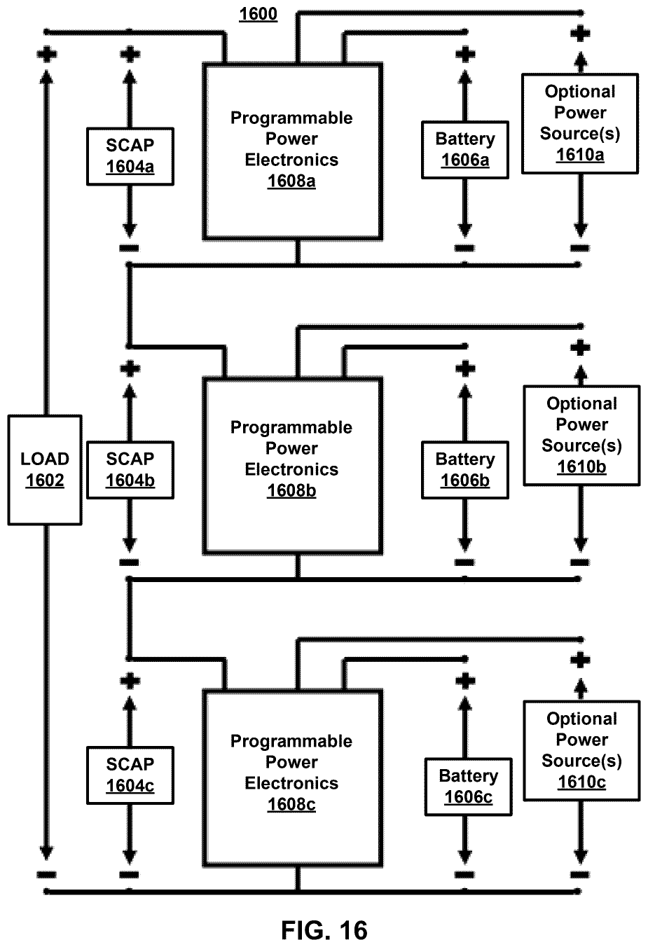

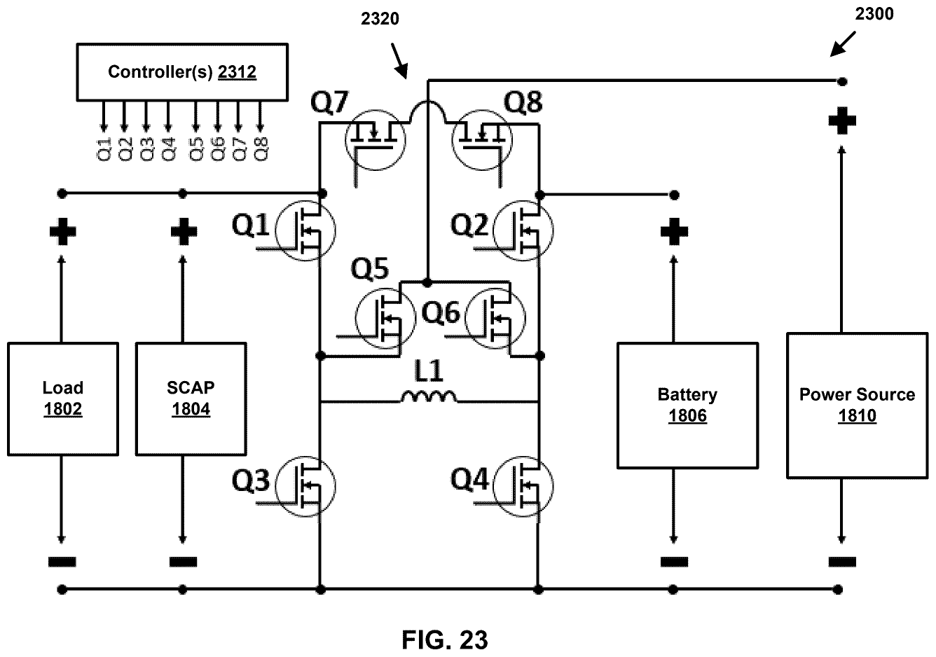

Described herein are novel methods of using hybrid energy storage devices and novel systems thereof. The systems can include a hybrid energy storage device that includes one or more supercapacitors, one or more batteries, and at least one converter (e.g., see FIGS. 15 to 20 and FIGS. 22 and 23, which illustrate example electronic systems in accordance with some embodiments of the present disclosure). Some examples of the storage device include a bypass circuit, e.g., see bypass circuit 2320 shown in FIG. 23. Some examples include control logic hardware or firmware, e.g., see programmable power electronics 1508 shown in FIG. 15 or the programmable power electronics 1608a, 1608b, and 1608c shown in FIG. 16, or any of the other programmable power electronics described herein. Furthermore, some examples can include external power sources. And, some examples can include a voltage probe.

The one or more supercapacitors can include one or more electric double-layer capacitor cells (EDLCs) in series or parallel combinations. Such cells can achieve selected voltage, power, and energy requirements or recommendations. In some examples, the storage device can include or utilize supercapacitor strings rated up to 16.2 volts and 133 Farads and up to 200 Farads.

The one or more batteries can be in series or parallel combinations to achieve selected voltage, power, and energy levels. Battery specifications can vary. In some examples, the one or more batteries include 12.8V, 20 amp-hour lithium iron phosphate modules and a 14.4V, 4 amp-hour lithium titanate battery.

The converter can include a bi-directional DC-DC converter (or multiple unidirectional DC-DC converters). Such a converter can manage power distribution of a system having the storage device.

In some examples, including a bypass circuit, the bypass circuit can include an electronic switch, such as a transistor or relay. The switch can be controlled to directly connect two or more sources when they are close in voltage. Such control of the switch can allow current to flow between the two or more sources without using the converter.

In some examples, including control logic hardware, such hardware can include sensors, processors, and memory for monitoring hardware and executing firmware logic. In some cases that include firmware, the firmware can include software logic used with or stored within the device to perform hardware monitoring and control functionality for operations, such as operations described herein, as well as to manage communication with internal or external devices. Firmware logic can also include voltage, temperature, and current parameters for various subcomponents, power source transfer rules and priorities, etc.

In some examples, including external power sources, the storage device or system thereof can include or be connected to one or more external power sources, such as solar panels, batteries, DC power supplies, etc., which can have power routed through the converter. Power sources can be unidirectional or bidirectional, depending on the embodiment.

In some examples, including a voltage probe, the probe can include a positive probe or negative probe, and corresponding connectors. The probes or connectors can be connected to a voltage sensing circuit within or attached to the storage device, such as to be used for measuring external voltage.

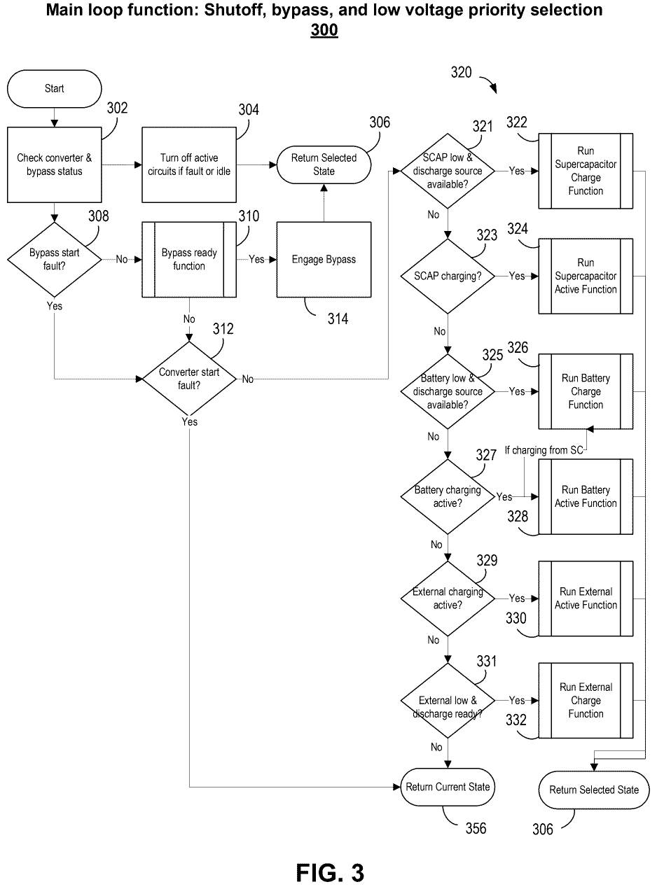

Some embodiments include a prioritization method (e.g., see FIGS. 3 to 10, which show prioritization methods, in accordance with some embodiments of the present disclosure). Some embodiments include an automated adaptive prioritization method for controlling power transfers in hybrid energy storage systems. Such systems can include one or more hybrid energy storage devices that utilize supercapacitors and batteries. Some examples include a method for prioritizing power transfers between multiple energy sources using a single bi-directional power converter using a control circuit.

Often, energy storage systems include management of power supply and demand. Existing systems often struggle with efficient power management when multiple sources are connected, and known technologies lack adaptive methods for prioritizing power transfers based on real-time parameters such as voltage, current, temperature, state-of-charge, source type, etc. To the contrary, in some embodiments, the systems or methods can include such adaptive methods.

Some examples include an automated, adaptive prioritization method that controls power transfers between two or more energy storage devices connected to a single bi-directional power converter. Such examples can include a method that dynamically adjusts priorities based on voltage levels, current limits, temperature readings, and other parameters, allowing for efficient energy management and enhanced system reliability.

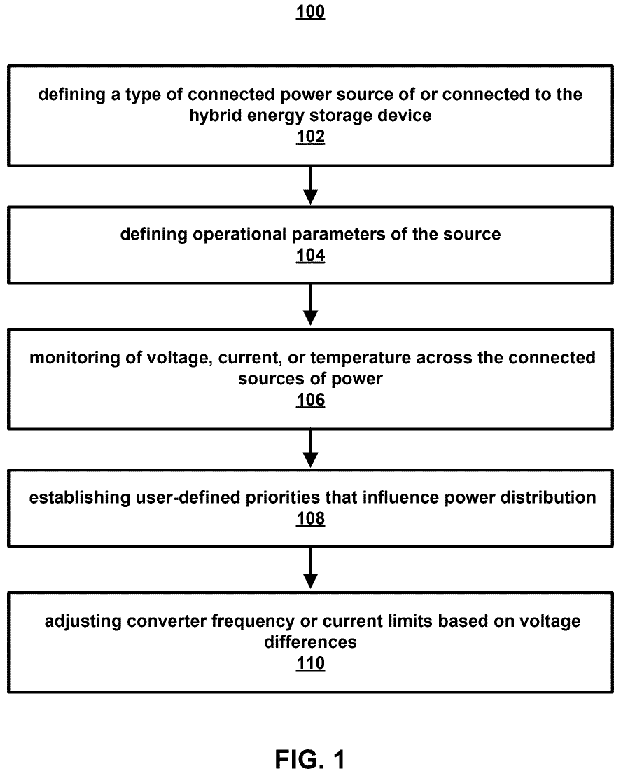

As shown in FIG. 1, a prioritization method 100 can include defining a type of connected power source of or connected to the hybrid energy storage device, at step 102, as well as defining operational parameters of the source, at step 104, wherein operational parameters of the power source can include minimum or maximum voltage, current, or temperature, various voltage targets or setpoints, hysteresis ranges for the various parameters, or logic that may vary the parameters based on operating conditions, such as in combination with other parameters. Also, as shown, the method 100 can include monitoring (such as continuous monitoring) of voltage, current, or temperature across the connected sources of power (e.g., see step 106). Also, as shown, the method 100 can include establishing user-defined priorities that influence power distribution (e.g., see step 108). Also, as shown, the method 100 can include adjusting converter frequency or current limits based on voltage differences (e.g., see step 110).

In some embodiments, method 100 or the like can provide automated adaptive source prioritization for hybrid energy storage with a single bi-directional (or multi-directional) converter and optional bypass. In some examples, the system thereof can include firmware or hardware logic that dynamically prioritizes power transfers among multiple sources or sinks (e.g., supercapacitor, battery, external sources, loads) based on real-time voltage, current, temperature, or SoC and user-defined priorities, while adjusting converter frequency or current limits, and engaging a bypass path when voltages match. This is beneficial because it can provide a control method or system for orchestrating power routing decisions across multiple sources and this is whether or not it is combined with a specific virtual voltage profile and a multi-directional converter topology.

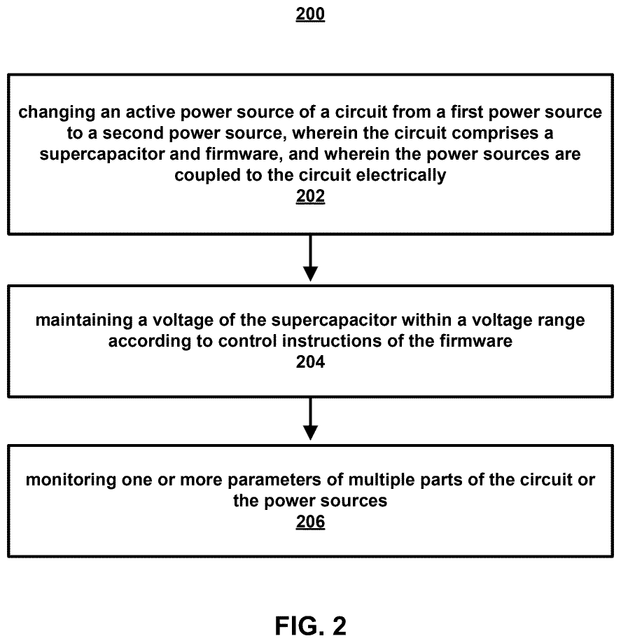

As shown in FIG. 2, another prioritization method 200 can include changing an active power source of a circuit from a first power source to a second power source, wherein the circuit includes a supercapacitor and firmware, and wherein the power sources are coupled to the circuit electrically (e.g., see step 202). In some examples, the method can include enabling or disabling the active power source of a circuit from the first power source to the second power source. In some embodiments, the circuit includes a DC-to-DC converter, and the maintaining of the voltage of the supercapacitor includes controlling the converter according to the control instructions. In some examples, the DC-to-DC converter is bidirectional. Also, in some examples, the circuit includes a bypass circuit to temporarily bypass the DC-to-DC converter, and the maintaining of the voltage of the supercapacitor includes switching current from the converter to the bypass circuit. Also, the maintenance of the voltage can occur while receiving power from the first power source or the second power source, or during the change from the first power source to the second power source. And, in some examples, the supercapacitor and a first power source are connected by the bypass circuit, and the DC-to-DC converter maintains the combined voltage of the supercapacitor and the first power source using a second power source.

Also, the method 200 can include maintaining a voltage of the supercapacitor within a voltage range according to control instructions of the firmware (e.g., see step 204). Also, the method 200 can include monitoring one or more parameters of multiple parts of the circuit or the power sources (e.g., see step 206). In some embodiments, the changing of the power source occurs according to the monitored one or more parameters. In some examples, the maintenance of the voltage of the supercapacitor occurs according to the monitored one or more parameters. In some cases, the monitored one or more parameters include voltage, current, or temperature. In some examples, the instructions of the firmware are modifiable via a user interface.

The prioritization method disclosed herein can provide significant improvements over existing energy management systems by providing a dynamic and automated approach to controlling power transfers in hybrid energy storage devices. The prioritization method can enhance efficiency in energy management by prioritizing power sources based on real-time data. It can improve system reliability through adaptive control mechanisms. It can provide flexibility in integrating multiple energy sources with varying characteristics. And, it can provide the ability to self-regulate power across several devices and sources without intervention external to the system or the device depending on the embodiment.

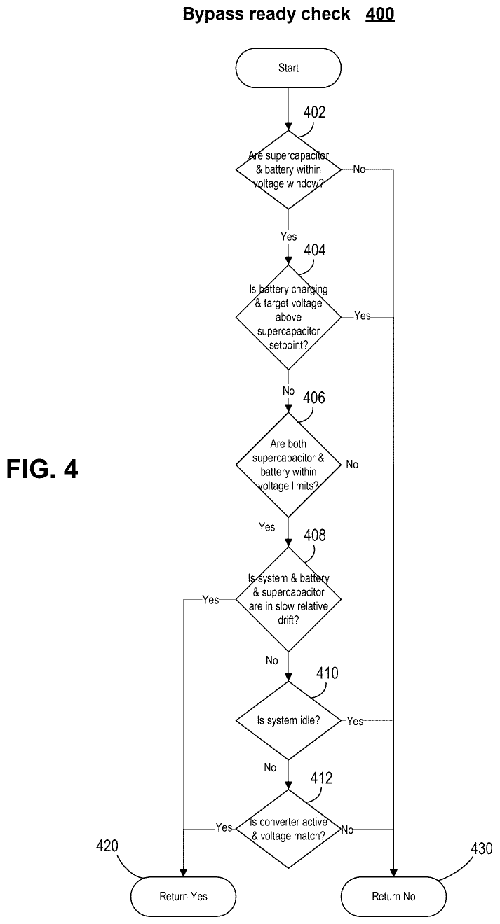

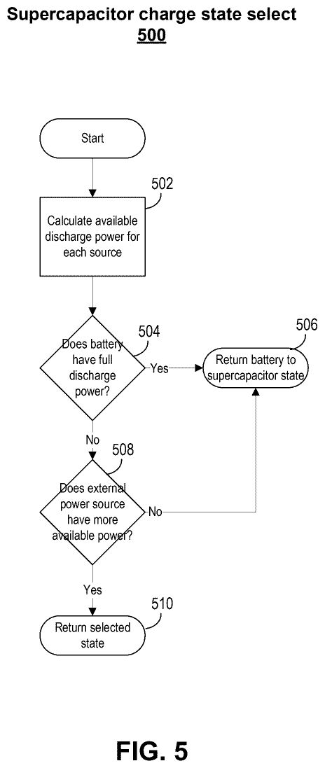

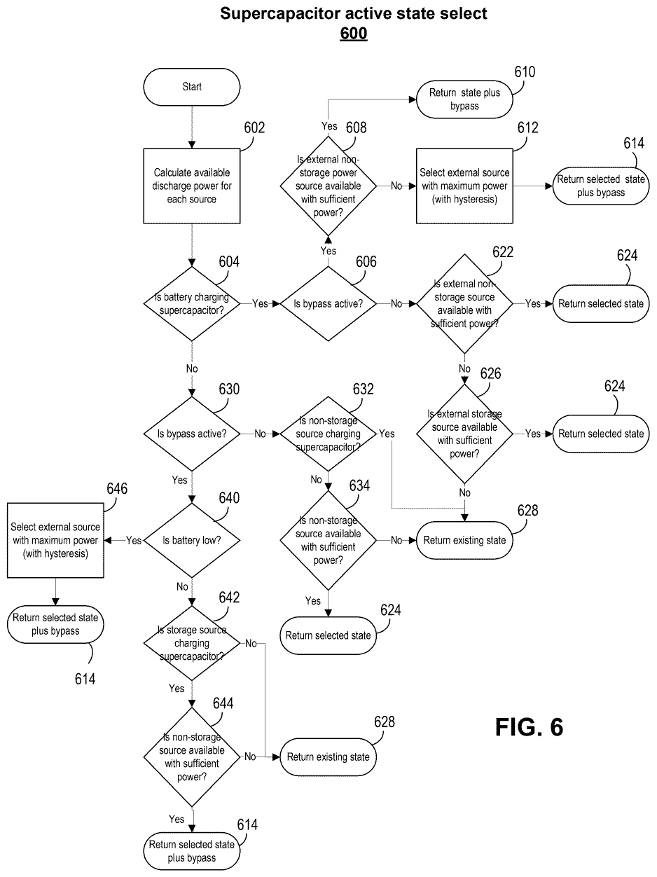

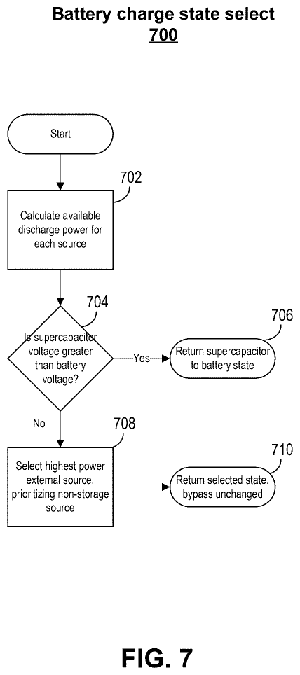

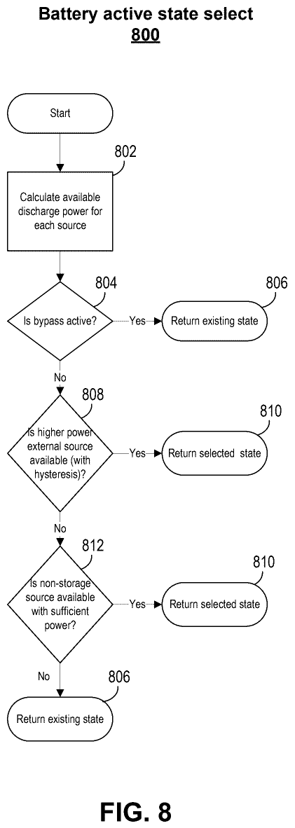

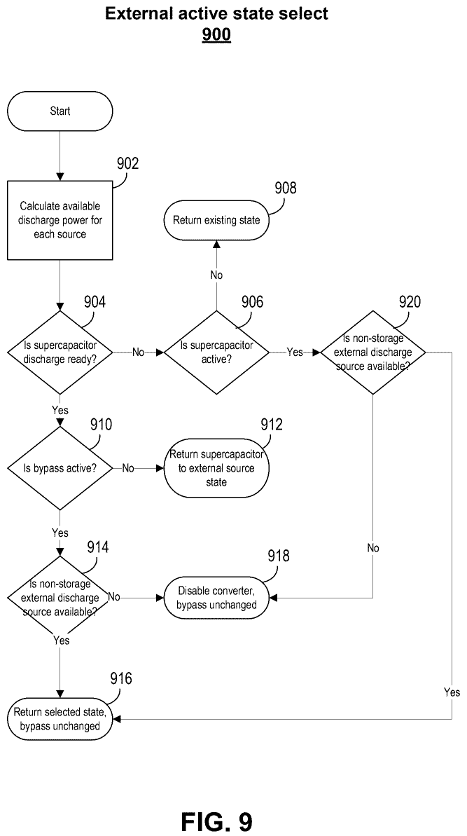

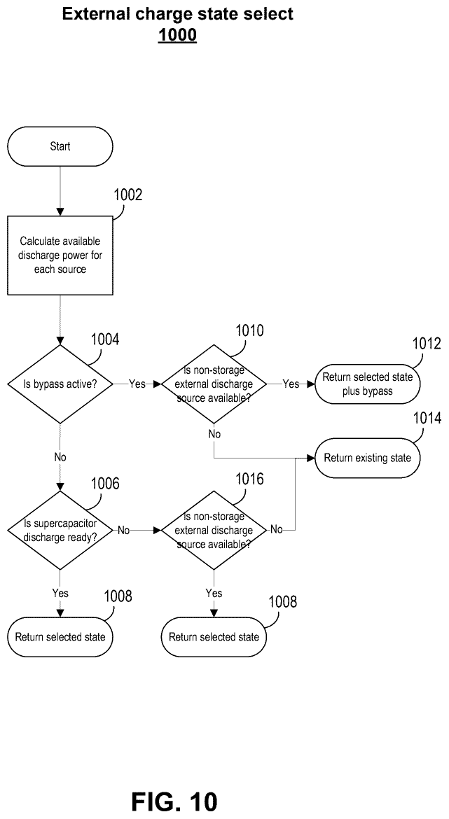

Example functions of the prioritization methods are illustrated in FIGS. 3, 4, 5, 6, 7, 8, 9, and 10. Specifically, FIG. 3 shows a target state check function or method 300. FIG. 4 shows a bypass ready function or method 400. FIG. 5 shows a supercapacitor charge function or method 500. FIG. 6 shows a supercapacitor active function or method 600. FIG. 7 shows a battery charge function or method 700. FIG. 8 shows a battery active function or method 800. FIG. 9 shows an external power source active function or method 900. And, FIG. 10 shows an external power source charge function or method 1000.

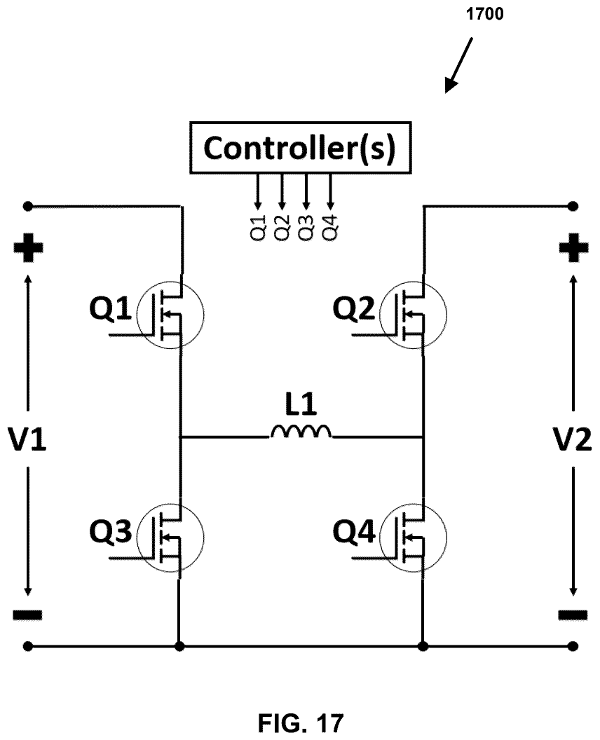

FIG. 3 shows a target state check function or method 300, which provides an example main loop function of the prioritization methods described herein, including a shutoff, bypass, and low voltage priority selections. As shown in FIG. 3, method 300 commences with step 302, wherein the method includes checking converter and bypass status (e.g., checking the status of converters 1700, 1800, 1900, 2000, 2200, and 2300 shown in FIGS. 17 to 20, 22, and 23, respectively, as well as corresponding bypass circuits such as bypass circuit 2320 shown in FIG. 23). At step 304, the method 300 includes turning off active circuits when a fault or idle status is found at step 302. At step 306, the method includes returning the converter to a selected state. At step 308, the method includes specifically determining when the bypass state starts a faulted condition. When the fault condition is not determined, a bypass ready function determines when the bypass is ready to be used—at step 310. When the faulted condition is determined at the bypass, the method includes specifically determining when the converter state starts a faulted condition—at step 312. Also, after step 310, when the bypass ready function determines the bypass is not ready to be used, the method includes specifically determining when the converter state starts a faulted condition—at step 312. After step 310, when the bypass ready function determines the bypass is ready to be used, the method includes engaging the bypass at step 314, and the method includes returning to a selected state by the bypass at 306.

In method 300, after the method specifically determines that the converter state started a faulted condition, the method includes returning the converter to its current state or default state at step 356. Otherwise, the method 300 runs a series of steps 320 to return the converter to a selected state (at step 306).

The series of steps 320 includes steps 321 to 332. At step 321, the method includes determining when a supercapacitor is low and a discharge source is available. When the supercapacitor is low and the discharge source is available, the method, at step 322, includes running a supercapacitor charge function to return the converter to a selected state (at step 306) via charging the supercapacitor. When the supercapacitor is not low or the discharge source is not available, at step 323, the method includes determining when a supercapacitor is charging. When the supercapacitor is charging or charged, the method, at step 324, includes running a supercapacitor active function to return the converter to a selected state (at step 306) via the active supercapacitor.

Also, as shown in FIG. 3, when it is determined that the supercapacitor is not charging or is charged, it is determined whether a battery is low and a discharge source is available—at step 325. When the battery is low and a discharge source is available, the method, at step 326, includes running a battery charge function to return the converter to a selected state (at step 306) via the charging the battery. And, when the battery is not low or a discharge source is not available, the method, at step 327, determines whether the battery is actively charging. When the battery is actively charging or charged, the method includes, at step 328, running a battery active function to return the converter to a selected state (at step 306) via the active battery.

Also, as shown in FIG. 3, when it is determined that the battery is not charging or is charged, it is determined whether external charging is active in the circuit (at step 329). When external charging is active, the method, at step 330, includes running an activation function for the external charging to return the converter to a selected state (at step 306) via the external charging (such as via an external power source providing energy to the circuit). And, when the external charging is not active, the method, at step 331, determines whether the external source of charging is too low in stored energy and a discharge is available. When the external source is low and the discharge is available, the method includes, at step 332, running a charge function for the external source to ultimately return the converter to a selected state (at step 306) via the charged external source. Otherwise, when the external source is not low or the discharge is not available, the series of steps 320 concludes with the circuit returning to the current or default state (at step 356).

Some examples include a user-defined setting for the prioritization method (such as a prioritization method including method 300 or the series of steps 320). In some embodiments of the methods of using a hybrid energy storage device or the systems thereof, users can customize device settings of the storage device or a system including the device. Such customization can be done through a user interface. The system or the device can adapt to priorities set through the user interface while maintaining operational efficiency to a selected level. The user interface can provide methods for interfacing with the device to update the settings of the device or the system, or modify the prioritization logic of the prioritization method. The user interface can include a screen and buttons for user interactions with the device. The interface can connect wirelessly with the device, such as via Bluetooth, LoRa, Wi-Fi, etc. The interface can also be through a USB connection, an SD card, or a programming port.

Some examples include current limit adjustments for the prioritization method. In some embodiments of the methods of using a hybrid energy storage device or the systems thereof, the methods or systems can include logic for varying current limits based on real-time data. Such logic can enhance operations to be within maximum current limits for each source, and thus, improve the safety in the use of the storage device. The data used as a basis for controlling the current limits can include current limit parameters. The converter and each source of the system or device can have maximum current thresholds for both input and output currents, and such thresholds can be included in the parameters. The parameters can also include converter frequency and current thresholds that can be based on converter input and output voltages. Also, converter current can be controlled using a voltage signal based on the logic. The logic can be a basis for the controlling of the switch of the device or system. Other converter topologies can also be used. Relevant voltage and temperature performance is continuously monitored and can be part of the parameters, and, when parameters are exceeded, current can be reduced or stopped. Also, bypass currents, such as currents of the bypass circuit, can be monitored. When engaged, the bypass circuit can be disengaged through fault monitoring when current, temperature, or voltage parameters fall outside selected limits.

FIG. 4 shows an example bypass ready function via method 400. In other words, method 400 includes determining whether a bypass is ready for use at state 420 or not ready at state 430 (such as determining whether any of the bypass circuits mentioned herein is ready for use, e.g., see bypass circuit 2320). As shown, method 400 commences, at step 402, with determining whether a supercapacitor or a battery of a circuit (such as a circuit for a converter) is within a voltage window. When it is not within the window, the method includes determining that the bypass is not ready for use by the circuit. Otherwise, the method 400, at step 404, continues with determining whether a battery is charging and a target voltage is above the supercapacitor setpoint. When the conditions are not met at step 404, the method includes determining that the bypass is not ready for use by the circuit. Otherwise, when the conditions of step 404 are met, the method, at step 406, continues with determining whether both the supercapacitor and the battery are within voltage limits. When the supercapacitor and the battery are not within voltage limits, the method includes determining that the bypass is not ready for use by the circuit. Otherwise, when such conditions are met at step 406, the method, at step 408, continues with determining whether the system, the battery, and the supercapacitor are in slow relative drift. When any one or more of such components are in slow relative drift, the method includes determining that the bypass is not ready for use by the circuit. Otherwise, when such conditions are met at step 408, the method, at step 410, determines when the circuit or the overall system is idle. When the conditions are not met at step 410, the method includes determining that the bypass is not ready for use by the circuit. Otherwise, when the conditions are met at step 410, the method, at step 412, determines whether the circuit (or, for example, a converter within the circuit) is active and there is a voltage match between one or more energy sources of the circuit. When the conditions are not met at step 412, the method includes determining that the bypass is not ready for use by the circuit. Otherwise, when the conditions of step 412 are met along with the other conditions of method 400, the method includes determining that the bypass is ready for use by the circuit.

Some examples include dynamic monitoring for the prioritization method. In some embodiments of the methods of using a hybrid energy storage device or the systems thereof, the methods or systems can include a monitor that can monitor and measure voltage and temperature levels across connected power sources, such as in real time. It can also monitor current at several points throughout the converter and across the bypass circuit, depending on the embodiment. In some cases, the monitor can categorize voltage sources into high, low, or out-of-specification based on predefined thresholds, and in relation to each other. The system can include voltage threshold specifications in which a power source of or connected to the storage device can have several voltage parameters of the specification used to compare against the measured voltage for determining relative voltage levels. Such parameters can include operating minimum, safety minimum, maximum, setpoint, charge-enabled, etc. Each parameter can include a hysteresis range—such as to prevent chattering.

With respect to the monitoring, the supercapacitor is considered low when it is below the charge-enabled voltage, and high when it is above a selected setpoint voltage. The voltage settings can be static or variable as a function of other conditions. For some logic profiles, as is the case in the sample flow charts provided above, high and low can also include the voltage level relative to a voltage of a selected battery or a virtual battery profile. With respect to the monitoring, the internal battery of the device or one externally connected can be considered to have a high voltage level when it is above the minimum voltage threshold. The battery can be considered low when it is below the charge-enabled voltage threshold. Because the battery can both store and release energy, the battery can have high and low levels simultaneously. Such variability can be factored into the prioritization logic depending on other conditions within the system.

FIG. 5 shows an example supercapacitor charge function via method 500. As shown, method 500 starts at step 502 with calculating available discharge power for each energy source in the circuit (such as in the converter of the circuit specifically, e.g., see converters 1700, 1800, 1900, 2000, 2200, and 2300 shown in FIGS. 17 to 20, 22, and 23, respectively, as well as their respective supercapacitors). From the calculation, the method includes determining whether the battery has full discharge power, at step 504. When the battery does have full discharge power, the battery returns to a state similar to the supercapacitor or vice versa, at step 506. Otherwise, when the battery does not have full discharge power, the method, at step 508, determines whether an external power source has more available power. When the external power source does not have more available power, the battery returns to a state similar to the supercapacitor or vice versa, at step 506. Otherwise, when the external power source does have more available power, the method returns at least the supercapacitor to a selected state at step 510. In some cases, the method return the battery to a selected state as well (at step 510).

FIG. 6 shows an example supercapacitor active function via method 600. As shown, method 600 starts at step 602 with calculating available discharge power for each energy source in the circuit (such as in the converter of the circuit specifically, e.g., see converters 1700, 1800, 1900, 2000, 2200, and 2300 shown in FIGS. 17 to 20, 22, and 23, respectively, as well as their respective supercapacitors). Based on the calculation at step 602, the method continues with determining when the battery is charging the supercapacitor—at step 604. When the battery is charging the supercapacitor, the method continues, at step 606, with determining whether the bypass is active. When the bypass is active, the method continues, at step 608, with determining whether an external non-storage power source is available with sufficient power for the circuit or the supercapacitor. When there is sufficient power, the method, at step 610, returns the supercapacitor to an active state and the bypass is used. Otherwise, when there is not sufficient power from the external non-storage power source, the method, at step 612, selects an external source with maximum power (such as selecting a power source via hysteresis). Then, based on operations of step 612, the supercapacitor can be returned to a selected state and the bypass is active as well (at step 614).

Also, as shown in FIG. 6, when the bypass is determined to be inactive at step 606, the method 600 continues, at step 622, with determining whether an external non-storage power source is available with sufficient power for the circuit or the supercapacitor. Then, based on operations of step 622, when there is sufficient power, the supercapacitor can be returned to a selected state (at step 624). In such an instance, the bypass may not be active. Otherwise, when there is not sufficient power from the external non-storage source, the method 600 determines whether an external storage source is available with sufficient power for the circuit or the supercapacitor at 626. When the storage source has enough power available, the supercapacitor can be returned to a selected state (at step 624). Otherwise, the circuit or supercapacitor returns to an existing state or a default state depending on the embodiment (at step 628).

Returning to the determination of whether the battery of the circuit is charging the supercapacitor at step 604, when such charging is not active the method 600 continues with determining whether the bypass is active—at step 630. When the bypass is not active, at step 632, the method includes determining whether a non-storage source is charging the supercapacitor. When a non-storage source is charging the supercapacitor, the circuit or supercapacitor returns to an existing state or a default state depending on the embodiment (at step 628). Otherwise, the method continues, at step 634, with determining whether a non-storage source is available with sufficient power to charge the supercapacitor or the circuit. When there is sufficient power, the circuit or supercapacitor returns to a selected state (at step 624). Otherwise, the circuit or supercapacitor returns to an existing state or a default state depending on the embodiment (at step 628).

Returning to determining whether the bypass is active at step 630, when the bypass is active, at step 640, the method includes determining whether that battery is too low in energy to support the supercapacitor or the circuit. When the energy stored in the battery is sufficient, the method continues, at step 642, with determining whether the energy storage source or the battery is charging the supercapacitor. When the charging is not active, the circuit or supercapacitor returns to an existing state or a default state depending on the embodiment (at step 628). Otherwise, the method 600 continues with determining, at step 644, whether a non-storage source is available with sufficient power to supply the supercapacitor or the circuit. When the non-storage source is available with sufficient power, the supercapacitor can be returned to a selected state and the bypass is active as well (at step 614). Otherwise, the circuit or supercapacitor returns to an existing state or a default state depending on the embodiment (at step 628).

Returning to the determination at step 640, when the battery is too low in energy to support the supercapacitor or the circuit, the method 600 continues, at step 646, with selecting an external energy source that can deliver maximum power (wherein the determination of the source can occur through hysteresis). After the selection, the supercapacitor can be returned to a selected state and the bypass is active as well (at step 614).

FIG. 7 shows an example battery charge function via method 700. As shown, method 700 starts at step 702 with calculating available discharge power for each energy source in a circuit (such as in the converter of the circuit specifically, e.g., see converters 1700, 1800, 1900, 2000, 2200, and 2300 shown in FIGS. 17 to 20, 22, and 23, respectively, as well as their respective batteries). At step 704, the method 700 includes determining whether a supercapacitor voltage is greater than a battery voltage in the circuit. When the supercapacitor voltage is greater than the battery voltage, the method includes returning the supercapacitor to a state similar to the state of the battery—at step 706. Otherwise, the method includes selecting an external energy source (e.g., the highest power external source) and prioritizing non-storage sources of the circuit—at step 708. After step 708, the method, at step 710, includes returning to a selected state and the state of the bypass is unchanged in the circuit.

FIG. 8 shows an example battery active function via method 800. As shown, method 800 starts at step 802 with calculating available discharge power for each energy source in a circuit (such as in the converter of the circuit specifically, e.g., see converters 1700, 1800, 1900, 2000, 2200, and 2300 shown in FIGS. 17 to 20, 22, and 23, respectively, as well as their respective batteries). At step 804, the method includes determining whether a bypass of the circuit is active. When the bypass is active, at step 806, the method includes returning to an existing state or a default state depending on the embodiment. Otherwise, when the bypass is not active, the method includes determining whether there is a higher power external source available (such as through hysteresis)—at step 808. When there is a higher power external source available, at step 810, the method includes returning the circuit to a selected state such as by returning the battery to a selected state. Otherwise, when there is not a higher external source available, the method includes, at step 812, determining whether a non-storage source is available with sufficient power. When a non-storage source is available with sufficient power, the method includes returning the circuit to a selected state such as by returning the battery to a selected state—at step 810. Otherwise, When a non-storage source is not available with sufficient power, the method includes returning to an existing state or a default state depending on the embodiment—at step 806.

Also, with respect to monitoring, input-only power sources, such as solar panels, battery chargers, etc., may only be able to deliver current and cannot receive current. A profile flag can prevent the converter from sending power to such sources. Such sources can be considered high, by the logic, when they are above the minimum voltage. Further, output-only sources of the system or device can be sources that can only receive current, such as secondary loads. Such output-only sources are considered to have low voltage levels when the voltage is below the charge-enabled voltage. In addition, in some cases, a separate command signal can be used before discharging to such types of sources.

FIG. 9 shows an example external power source active function via method 900. As shown, method 900 starts at step 902 with calculating available discharge power for each energy source in a circuit (such as in the converter of the circuit specifically, e.g., see converters 1700, 1800, 1900, 2000, 2200, and 2300 shown in FIGS. 17 to 20, 22, and 23, respectively, as well as their respective optional power sources which can include external power sources, for example, see optional power sources 1510, 1610a, 1810, V2, and VN). At step 904, the method 900 includes determining whether the supercapacitor discharge is complete or at least the supercapacitor is ready for use, depending on the embodiment. When the supercapacitor discharge is not complete or at least the supercapacitor is not ready for use, the method, at step 906, includes determining whether the supercapacitor is active. When the supercapacitor is not active, the method, at step 908, includes the circuit returning to an existing state or a default state depending on the embodiment.

When the supercapacitor discharge is complete or at least the supercapacitor is ready for use, depending on the embodiment, the method 900 includes determining whether a bypass of the circuit is active—at step 910. When the bypass is not active, the method includes, at step 912, returning the supercapacitor to a state similar to an external source. Otherwise, at step 914, the method includes determining whether a non-storage external discharge source is available in the circuit. When there is a non-storage external discharge source available in the circuit, the method includes, at step 916, returning the circuit to a selected state and the state of the bypass remains active. Otherwise, when there is no non-storage external discharge source available in the circuit, the method includes disabling the converter and the bypass remains active—at step 918.

Returning to when the supercapacitor discharge is not complete or at least the supercapacitor is not ready for use, depending on the embodiment, when it is determined that the supercapacitor is active at step 906, the method 900 includes determining whether a non-storage external discharge source is available—at step 920. When a non-storage external discharge source is not available, the method includes disabling the converter and the bypass remains active—at step 918. Otherwise, when the external source is available, the method includes, at step 916, returning the circuit to a selected state and the state of the bypass remains active.

FIG. 10 shows an example external power source charge function via method 1000. As shown, method 1000 starts at step 1002 with calculating available discharge power for each energy source in a circuit (such as in the converter of the circuit specifically, e.g., see converters 1700, 1800, 1900, 2000, 2200, and 2300 shown in FIGS. 17 to 20, 22, and 23, respectively, as well as their respective optional power sources which can include external power sources, for example, see optional power sources 1510, 1610a, 1810, V2, and VN). At step 1004, the method includes determining whether a bypass of the circuit is active. When the bypass is not active, at step 1006, the method includes determining whether the supercapacitor discharge is complete or at least the supercapacitor is ready for use, depending on the embodiment. When the supercapacitor discharge is complete or at least the supercapacitor is ready for use, the method includes returning the circuit to a selected state such as by returning the battery to a selected state —at step 1008.

When the bypass is active, the method 1000 includes determining whether a non-storage external discharge source is available—at step 1010. When a non-storage external discharge source is available, the circuit returns to a selected state and the bypass remains active—at step 1012. Otherwise, when a non-storage external discharge source is not available, the method includes the circuit returning to an existing state or a default state depending on the embodiment—at step 1014.

Returning to when the bypass is not active, and when supercapacitor discharge is not complete or at least the supercapacitor is not ready for use, depending on the embodiment, at step 1016, the method continues with determining whether a non-storage external discharge source is available. When the non-storage external discharge source is available, the method includes returning the circuit to a selected state such as by returning the battery to a selected state—at step 1008. Otherwise, when the non-storage external discharge source is not available, the method includes the circuit returning to an existing state or a default state depending on the embodiment—at step 1014.

Some examples include temperature considerations for the prioritization method. The monitor can also monitor and measure temperature at different points of the device or system. The temperature readings can be integrated into a prioritization scheme to prevent overheating in the device or system. The device or system can use de-rating strategies near temperature extremes. For example, temperature thresholds can be used with the converter and one or more of the power sources can have minimum and maximum temperature thresholds for both input and output current, with hysteresis ranges for example. Once any relevant temperature reaches a hysteresis range, current can be reduced proportionally until it is cut off according to a corresponding temperature-based limit.

In some embodiments, the system includes a firmware-controlled virtual voltage profile for hybrid energy storage systems using supercapacitors. Some embodiments include an energy storage system that leverages supercapacitors. Also, some examples include a method for creating a firmware-controlled virtual voltage profile that can mimic battery voltage performance or generate custom voltage profiles adaptable to varying operational conditions.

Often, energy storage systems encounter challenges in delivering stable and reliable power outputs under varying conditions. Known batteries can have fixed voltage profiles and power limitations, which may not be optimal for many applications. As disclosed herein, some embodiments include the ability to create a dynamic, firmware-controlled voltage profile using supercapacitors that can enhance system performance and adaptability across various use cases and conditions.

Some examples include a method for employing supercapacitors to establish a firmware-controlled virtual voltage profile. Such a profile can simulate the voltage characteristics of various types of batteries or be customized to meet specific operational requirements based on real-time readings of voltage, current, or temperature.

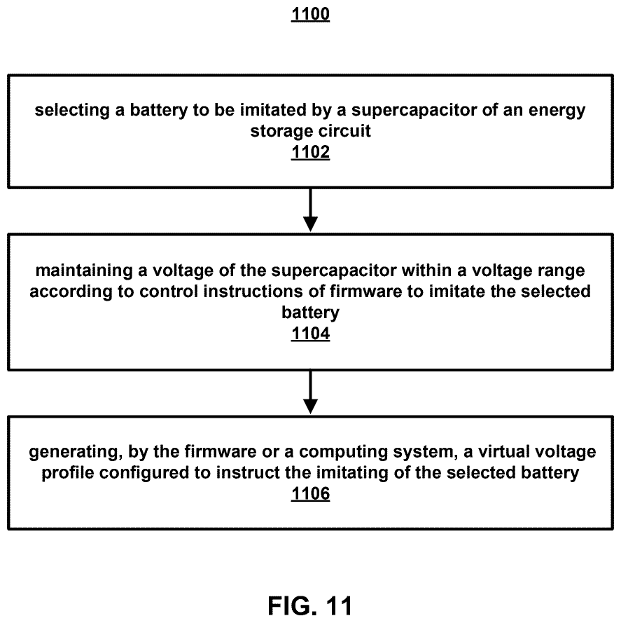

As shown in FIG. 11, a method for employing supercapacitors to establish a firmware-controlled virtual voltage profile can include selecting a battery to be imitated by a supercapacitor of an energy storage circuit (e.g., see method 1100 and step 1102). The method 1100 can also include maintaining a voltage of the supercapacitor within a voltage range according to control instructions of firmware to imitate the selected battery (e.g., see step 1104). The method 1100 can also include monitoring one or more parameters of multiple parts of the circuit or power sources coupled to the circuit electrically. In some examples, the maintenance of the voltage of the supercapacitor occurs according to the monitored one or more parameters. In some cases, the monitored one or more parameters include voltage, current, or temperature. In some examples, the circuit includes a DC-to-DC converter, and wherein the maintaining of the voltage of the supercapacitor includes controlling the converter according to the control instructions. In some cases, the DC-to-DC converter is bidirectional. In some embodiments, the circuit includes a bypass circuit to temporarily bypass the DC-to-DC converter, and the maintaining of the voltage of the supercapacitor includes switching current from the converter to the bypass circuit.

The method 1100 can also include generating, by the firmware or a computing system, a virtual voltage profile configured to instruct the imitating of the selected battery (e.g., see step 1106). In some cases, the instruction for the imitating of the selected battery serves as a basis for controlling the circuit to mimic discharge characteristics of the selected battery. In some examples, the parameters of the profile are configured to replicate various battery chemistries or other profiles of the selected battery and include at least a maximum voltage, a minimum voltage, or an operational temperature range.

In some embodiments, method 1100 or the like can provide firmware-controlled virtual voltage profile using supercapacitors. A system thereof can include using one or more supercapacitor under converter control to emulate a selected battery chemistry or voltage behavior (or a custom profile), including target-voltage logic that adapts to load, temperature, SoC, etc. Such a system can supports drop-in replacement and compatibility use cases. The control of a virtual battery behavior can be independent or combined with the prioritization logic and can be practiced with different converter topologies so it is not limited to operating with multi-directional converter topologies.

The profile or a method using the profile can increase flexibility in energy management through customizable voltage profiles of various parts of the device or system. The profile can also enable compatibility of hybrid energy storage systems with existing and legacy equipment. The profile can also provide for improved safety and reliability by preventing extreme operating conditions. And, the profile can provide enhanced performance in applications with variable load requirements. The firmware-controlled virtual voltage profile using supercapacitors represents a significant advancement over known energy storage solutions by providing dynamic adaptability, improved power handling capabilities, and enhanced operational efficiency.

In some embodiments, performance metrics of the virtual voltage profile can include efficiency in power delivery, response time to changes in load conditions, similarity to the voltage profile of a simulated device, fault-free operation of relevant equipment with a hybrid energy storage device, etc.

Potential applications of the system include enhancements to renewable energy systems where variable output is common as well as electric vehicles that require flexible power management. Also, the applications can include existing charging equipment designed for a specific battery chemistry or equipment that monitors or reacts to high or low battery voltage conditions.

Use Case examples of the system include drop-in replacement for automotive starter batteries as well as drop-in replacement for generator starter batteries. Examples of use of the system also include storing and smoothing power from solar panels. Examples of use of the system also include charging the device from an available battery charger (e.g., lead-acid or another chemistry-specific charger). Examples of use of the system also include drop-in replacement for batteries in a UPS system as well as drop-in replacement for batteries connected to and managed by inverters.

Some embodiments include the creation of a virtual voltage profile. In some examples, the system generates a virtual voltage profile capable of mimicking the discharge characteristics of a certain type of selected battery while adapting dynamically based on data inputs such as real-time data inputs. The profile can include profile parameters. The parameters can be set to replicate various battery chemistries or other profiles (for example, a linear voltage profile between two setpoints) depending on the output system. The parameters can include maximum voltage, minimum voltage, target voltage (fixed or calculated as a function of other parameters), target converter current as a function of the target voltage, existing voltage, and other parameters such as temperature. The parameters can be derived from various inputs that are entered or sensed inputs that can include converter current, bypass current (if applicable), input source voltage, input source state-of-charge, various system temperatures, and calculated energy input or output.

Some embodiments include a firmware control mechanism. In some examples, the system includes a firmware-based control mechanism. The firmware can monitor voltage, current, and temperature across power sources and electronics, adjusting the virtual voltage profile, such as adjusting it in real time. Also, in the generation of the profile, the first step can be to determine the supercapacitor target voltage. When it is not a predetermined fixed voltage value, various types of profiles can be used. Such profiles can be used with simple tweaks to a target voltage logic. The target voltage logic can also incorporate other input data, such as a condition of the connected load, as part of the profile logic. In some cases, the system can be configured to determine the voltage profile to be used. It may be preset, or it may actively switch between voltage profiles depending on system conditions or user input.

In the generation of the virtual voltage profile according to various types of sources, the basis for the profile can be according to a specific battery type or types. Many types of equipment monitor voltage and current to estimate battery state-of-charge. Such devices may alter their load characteristics or pass along monitoring data. For example, battery chargers can change operation based on output voltage with modes like constant current, constant voltage, or float.

Also, the basis for generation of the profile can be according to a linear voltage device. This can simplify the state-of-charge tracking. Furthermore, the basis for the generation of the profile can be according to a variable current device. This can allow connected equipment to infer active current based on voltage. For example, lower voltage would indicate a higher output current, or vice versa. Also, such a basis can be useful for power-leveling where a maximum or consistent power level is selected as the load varies. Also, the basis for generation of the profile can be according to a voltage stabilization mechanism or device. Such voltage stabilization mechanism or device can reduce voltage swings. For example, a battery can have a mostly stable voltage profile but significantly increase voltage at higher states of charge, or significantly decrease voltage at lower states of charge. These voltage swings could stress or exceed voltage limits of the installed equipment. Also, the basis for the generation of the profile can be according to a voltage following mechanism or device that mimics internal battery characteristics to protect against extreme currents. Such a device or mechanism can protect the mimicked source from extreme currents or voltages, thereby reducing the stress placed on that source. Also, such a device or mechanism can enable active control of one or more hybrid storage devices using a fluctuating reference voltage or via external command logic.

Some embodiments include virtual battery target voltage logic in the firmware. In some embodiments, instructions of the firmware can select a pre-set virtual battery profile. The instructions can also determine a reference used to assess the state of charge (SoC) of the corresponding energy storage device or source, such as a connected battery, solar panel, external charger, etc. The instructions also include other pre-set logic that can control actions of the system based on available monitored parameters. The instructions can also control actions of the system based on externally provided logic or commands. The instructions can further record the reference parameters (e.g., voltage, current, temperature, etc.) as well as estimate the SoC based on the reference parameters or alternative logic. The instructions can also look up or calculate the equivalent SoC target voltage for the virtual voltage profile. Such a lookup can be based on the values of a target voltage lookup table or calculation that can incorporate converter or bypass load current conditions, temperatures, etc. when specified (such as via the user interface).

Some embodiments include adaptive response features in the firmware or the system in general. In some embodiments, the system can provide adaptive capabilities that adjust the target voltage based on load demands, temperatures, etc., or that can implement safety protocols to prevent over-voltage or under-voltage conditions, over or under temperature conditions, etc. For example, via the firmware, the operating logic can compare supercapacitor voltage to target voltage. When supercapacitor voltage is below the target, the system can check input source capability and adjust converter direction accordingly. When the supercapacitor voltage is above the target, the system can check input source capability and adjust converter direction accordingly. The operating logic can also manage the system to maintain selected parameters to be within acceptable limits or otherwise disable current at certain points of the system. When any relevant system parameters are close to their limits and within a hysteresis range, the logic can proportionally reduce the maximum current limit for that portion of the system (e.g., change converter input or output currents or power source input or output currents). Also, when any existing currents exceed set maximum current limits, the system can reduce the converter current. Also, the system can increase the converter current depending on the scenario.

In some embodiments, methods or systems include an automated source current limit correction in the energy storage system. Some embodiments include an automated source current limit correction in the energy storage system (such as a hybrid energy storage device or corresponding system). In some examples, for an energy storage system, such as hybrid devices that leverage supercapacitors and batteries, the system can provide an automated method for correcting source current limits in response to voltage fluctuations, enhancing system reliability and preventing overcurrent conditions.

Often, overcurrent situations in power electronics may damage components and reduce system efficiency. Existing systems often lack the capability to dynamically adjust current limits based on real-time voltage monitoring. The system can provide an automated correction mechanism that can significantly improve the safety and performance of energy storage devices.

Some examples include a method for automated source current limit correction, wherein the controller logic can monitor voltage levels (such as continuously monitoring voltage levels). When a voltage drops below a predefined minimum threshold, the system automatically reduces the maximum allowable current or power output, as well as the current ramp rate. This proactive approach helps prevent future overcurrent situations and enhances overall system stability.

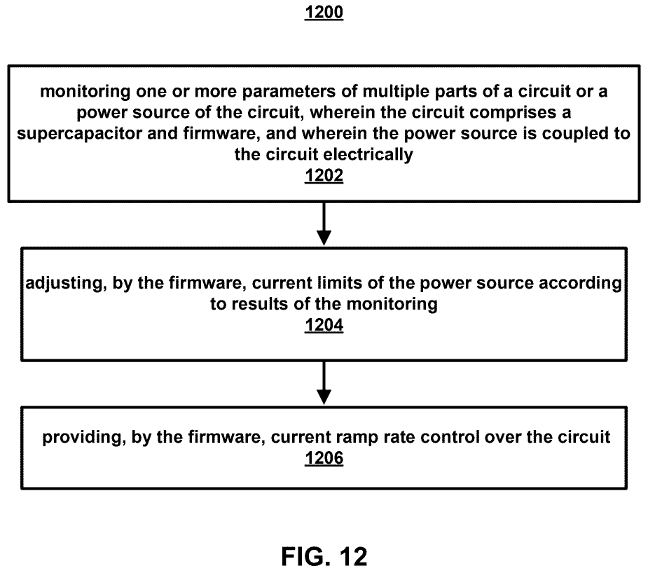

As shown in FIG. 12, a method 1200 for automated source current limit correction can include monitoring one or more parameters of multiple parts of a circuit or a power source of the circuit, wherein the circuit includes a supercapacitor and firmware, and wherein the power source is coupled to the circuit electrically (e.g., see step 1202). Also, the method can include adjusting, by the firmware, the current limits of the power source according to results of the monitoring (e.g., see step 1204). The monitored one or more parameters can include voltage, current, or temperature. Also, the monitoring of one or more parameters of multiple parts of the circuit can include monitoring one or more parameters of the supercapacitor, inputs of the supercapacitor, or outputs of the supercapacitor. The circuit can include a DC-to-DC converter, and the monitoring of one or more parameters of multiple parts of the circuit can include monitoring one or more parameters of the converter, inputs of the converter, or outputs of the converter. In some cases, the DC-to-DC converter is bidirectional. In some examples, the circuit includes a bypass circuit to temporarily bypass the DC-to-DC converter, and the monitoring of one or more parameters of multiple parts of the circuit includes monitoring one or more parameters of the bypass circuit, inputs of the bypass circuit, or outputs of the bypass circuit. And, in some examples, the supercapacitor and a first power source are connected by the bypass circuit, and the DC-to-DC converter maintains the combined voltage of the supercapacitor and the first power source using a second power source.

The method 1200 can further include providing, by the firmware, current ramp rate control over the circuit (e.g., see step 1206). In some embodiments, the current ramp rate control includes controlling current levels of the converter, inputs of the converter, or outputs of the converter. In some examples, the current ramp rate control is based on a variable voltage feedback signal using an adjustable pulse-width modulation (PWM). In some cases, the current ramp rate control is based on a variable voltage feedback signal using a Digital to Analog Converter (DAC) voltage.

The effectiveness of the automated source current limit correction can be evaluated based on frequency of overcurrent events before and after implementation, system response times during voltage fluctuations, and the success rate for preventing overcurrent situations, for example. Advantages of the correction method can include enhanced safety through proactive management of current limits in response to voltage drops or temperature spikes. Also, benefits can include improved reliability and longevity of components by preventing overcurrent conditions as well as increased operational efficiency by maintaining optimal performance under varying load conditions. In short, the automated source current limit correction method can provide significant advancements in energy storage systems by ensuring real-time responsiveness to voltage or temperature fluctuations, thereby enhancing safety and performance.

Some embodiments include a voltage monitoring mechanism for an automated source current limit correction. In some examples, the system uses the control logic hardware and firmware to continuously monitor voltage or temperature levels across connected sources. Also, the system can monitor input and output current within the converter and across bypass circuits, when applicable.

Monitored operating parameters can correspond to parameters or aspects of the supercapacitor, internal battery, and connected power sources including minimum and maximum voltage, current, or temperature, various voltage targets or setpoints, used to assess voltage status, or hysteresis ranges for the various parameters.

The firmware or control logic can include automated current limit adjustment. The control logic hardware can operate and monitor (such as continuously) the converter to control the transfer of power between sources. Firmware instructions can be used that account for the various monitored parameters and setpoints. And, when the converter is active, and the input source voltage suddenly drops below the minimum threshold, the controller disables current flow from the affected power source. Or, in such a scenario, the controller logic can automatically reduce the maximum current limit below the current at the time of the voltage drop. Also, the converter can be allowed to restart. As the current approaches the new current limit, the current ramp rate is slowed to reduce the risk of a sudden voltage drop. Depending on the source type and user settings, the firmware can allow the current to continue slowly increasing toward the original current limit after a set period. As the current safely increases towards the original limit, the reduced current threshold is continuously updated. When the voltage suddenly drops again, the process can be repeated. Fault handling logic can take additional action depending on the frequency or consistency of sudden voltage drops, up to and including disabling a power source. The system can also monitor other parameters, such as temperature, to detect sudden spikes and impose appropriate current limiting.

Also, the firmware or control logic can include current ramp rate control. In some cases, the system implements a controlled ramp rate for current adjustments. For example, the system can gradually increase converter current to avoid sudden changes that could destabilize the system. Such control can occur by sending the converter controller a variable voltage feedback signal using an adjustable pulse-width modulation (PWM) or Digital to Analog Converter (DAC) voltage. The voltage level of this signal can be used to limit the current allowed.

In some examples, ramp rate of the voltage signal is typically set in the firmware. For example, it may be set to limit the rate-of-change of the current control signal, such as 5 seconds to reach the maximum current. Also, for example, a second, slower ramp rate may be used as the current approaches the maximum limit. For example, once the current reaches 80% of the maximum value, the ramp rate may increase to 10 or 20 seconds to reduce the risk of rapid overcurrent voltage drops at high current. Repeated voltage drops may result in increased ramp rates as designed in the firmware logic.

The system can take preventative measures to avoid overcurrent situations. For example, the controller logic includes instructions for preventing overcurrent situations using adaptive learning algorithms that adjust thresholds based on historical data. Also, the logic can use or include user-defined settings for maximum allowable current based on application requirements.

In some examples, the minimum voltage parameter has a hysteresis range in which the current limit is reduced proportionally as the voltage approaches the minimum value. A sudden voltage drop indicates that the ramp rate and current limit hysteresis protection is not fast enough to respond to overcurrent conditions, also necessitating a decrease in the current ramp rate. Repeated voltage drops may result in increased ramp rates as set in the firmware logic. The time between voltage drops, or the total number of voltage drops, may be logged by the firmware. Logged voltage drop data can be used to vary the current limit and ramp rate parameters, with lower current or slower ramp rates for repeated and frequent voltage drops. Thresholds can also be used to temporarily or permanently disable a voltage source. For hybrid energy storage systems with several power sources, current limit is one of several parameters used to prioritize source usage. Also, fault logic can use onboard communication capabilities to send a fault message.

In some embodiments, method 1200 or the like provides automated source current-limit correction with adaptive ramp-rate control based on voltage or temperature events. A system thereof can include continuous monitoring and upon voltage dips below threshold (or temperature spike), dynamically reduce current limits, slow ramp, optionally disable or recover, and adapt future limits or ramp rates based on event history (e.g., using hysteresis and machine learning). The benefit of such a system is that it focuses on protective control of current limits and ramp behavior and can be valuable across many different types converters and energy storage systems such as systems including or not including source prioritization and virtual profiles.

In some examples, the methods or systems include self-charging and self-discharging mechanisms for energy storage devices. Some embodiments include self-charging and self-discharging mechanisms for energy storage devices (such as hybrid energy storage devices). For example, for energy storage devices, such as devices that leverage supercapacitors and batteries, the system can provide self-charging and self-discharging features that enhance user convenience and safety.

Often, with energy storage systems, such as hybrid systems, managing charge levels and ensuring safe handling of components is crucial. Traditional systems often require manual intervention to manage charging and discharging processes, which can be inefficient and potentially hazardous. Some examples of the systems described herein can provide an automated approach to self-charging and self-discharging that can improve operational efficiency and user safety.

Some examples include a method for an energy storage device (such as a hybrid energy storage device) to automatically charge to a user-defined voltage or an external voltage measurement using a voltage probe. Additionally, the system or the device can include automated discharge mechanisms to either safely store energy in an internal battery or discharge supercapacitor energy through resistive elements. The system can also switch between operational modes, including an activation mode that wakes the device from sleep and charges the supercapacitors to a preset setpoint.

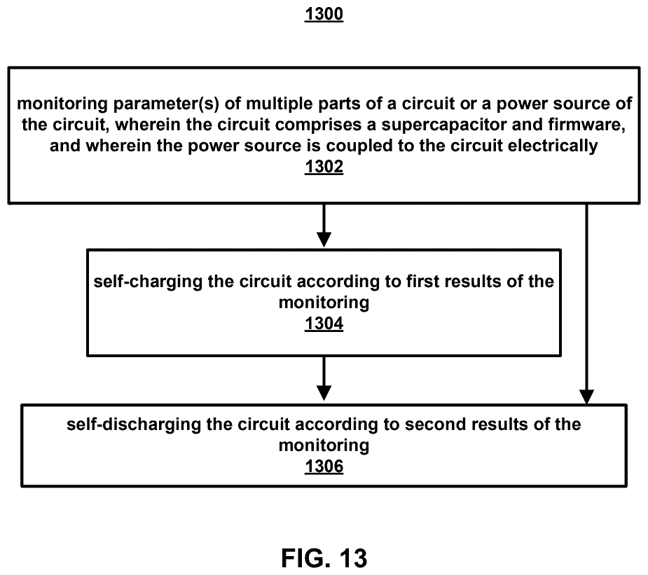

As shown in FIG. 13, a method 1300 for self-charging and self-discharging can include monitoring one or more parameters of multiple parts of a circuit or a power source of the circuit, wherein the circuit includes a supercapacitor and firmware, and wherein the power source is coupled to the circuit electrically, e.g., see step 1302, as well as self-charging the circuit according to first results of the monitoring, e.g., see step 1304. The method 1300 can also include self-discharging the circuit according to second results of the monitoring, e.g., see step 1306. In some embodiments, the self-discharging includes discharging the supercapacitor. In some examples, the self-charging includes charging the supercapacitor. The monitored one or more parameters can include voltage, current, or temperature. The monitoring of one or more parameters of multiple parts of the circuit can include monitoring one or more parameters of the supercapacitor, inputs of the supercapacitor, or outputs of the supercapacitor.

The method 1300 or the like can provide a system that includes self-charging and self-discharging mechanisms including activation or sleep modes and external voltage probe targeting. Such a system can include automatic charging to user-defined or externally measured voltage via probes as well as provide automated discharge via battery storage or resistive path. Such a system can provide an activation mode that activates the device and charges supercapacitors to a preset setpoint. Such a system is beneficial in its operational features and user-safety or handling routines, for example. And, such a system can be combined with the prioritization and current-limit features (or not).

In some examples, the circuit includes a DC-to-DC converter, and the monitoring of one or more parameters of multiple parts of the circuit includes monitoring one or more parameters of the converter, inputs of the converter, or outputs of the converter. In some examples, the DC-to-DC converter is bidirectional. In some embodiments, the circuit includes a bypass circuit to temporarily bypass the DC-to-DC converter, and the monitoring of one or more parameters of multiple parts of the circuit includes monitoring one or more parameters of the bypass circuit, inputs of the bypass circuit, or outputs of the bypass circuit.

The effectiveness of the self-charging and self-discharging mechanisms can be evaluated based on charging or discharging speed and efficiency, safety during and after discharge processes, and user satisfaction with automated features. The effectiveness can be analyzed and tested as well. Quick self-discharge from the supercapacitor to the battery should take a few minutes depending on the energy capacity of the supercapacitor and the input current capability of the output source (which depends on several factors like state-of-charge, temperature, defined current limits, etc.). It can gradually slow down towards the end of the discharge cycle as the voltage difference increases across the converter. Self-charging can follow similar constraints but will generally be faster. Resistive discharging can be much slower depending on the size and initial charge of the supercapacitor. It could take up to a full day or more to reach storage voltage and will generate dissipative heat during the process. Evaluation and testing can be done to measure the discharge time and impact of the dissipative heat.

Advantages of the self-charging and discharging include enhanced user convenience through automated charging and discharging processes, eliminating the need for external charging or discharging or monitoring equipment in many use cases. Improved safety by ensuring supercapacitor is managed effectively during operation. This includes de-energizing supercapacitors for safe storage and handling, and matching system voltages to prevent current spikes when connecting equipment. And, flexibility in operation modes allows for tailored user experiences. In short, the self-charging and self-discharging mechanisms described herein provide significant advancements in hybrid energy storage systems by automating critical processes, enhancing user safety, and improving overall efficiency.

In some embodiments, the self-charging mechanism can include a method starting with the device measuring external voltage levels via the voltage probes or connections or accepting user input for a voltage setpoint. The user input could be provided using a physical device interface or via wired or wireless communications. The method can continue with, upon receiving an appropriate command, either through external input or internal control logic, determining the selected supercapacitor voltage using the voltage detection circuit or user-defined input value. Then, the control logic can initiate an auto-charging or discharging process to reach a specified or predetermined supercapacitor voltage level. The system can also reset the permanent voltage setpoint based on an input per default or user settings. Also, the control logic hardware can monitor charging parameters such as measure voltage inputs from voltage, temperature, and current sensing circuits, and use firmware instructions to operate the converter. The converter can distribute power into the supercapacitor from the other internal or external power sources according to firmware logic to achieve a certain supercapacitor voltage.

In some embodiments, the self-discharging mechanism can include two different methods. One method can include an automated storage feature. Like the charging process, the system can direct the converter to discharge stored energy from supercapacitors into the internal battery or other connected sources for safe handling. This process can be designed to be fast and efficient. Alternatively, the second method can include a slow discharge process. Supercapacitors can discharge through an internal resistive element or elements (e.g., balancing resistors) to safely dissipate energy and reduce voltage. Such a slow discharge process may be useful in the event the other sources are fully charged or otherwise not capable of receiving input current. With respect to discharge parameters, the control logic hardware can monitor voltage inputs from voltage, temperature, and current sensing circuits, and use firmware instructions to operate the converter. The converter can distribute power out of the supercapacitor to the other internal or external power sources according to firmware logic to achieve a certain supercapacitor voltage.

In some cases, the system or device can include an activation mode in addition to a sleep mode. Upon activation, the device or system charges the supercapacitors to an internally or externally defined setpoint. Such a feature ensures readiness for immediate use while maintaining safe handling or conserving power during storage. Activation can be triggered by manual or automated means, based on a combination of external signals and internal logic, or activation parameters in general. For example, a user can enter an activation command physically or through wired or wireless means. The device can also monitor external enabling or triggering parameters such as voltage or temperature or activate on a set schedule.

In some cases, the user interface can enhance the self-charging and discharging mechanisms. Users can interact with the device through a user interface to set selected voltages or activate modes. This can be done through a physical interface or via wired (e.g., USB, CAN, etc.) or wireless (Bluetooth, Wi-Fi, etc.) connections. Feedback mechanisms such as a unit display, or wired or wireless communications, can inform users of charging or discharging status and any required actions. The logic can request command confirmations or additional inputs.

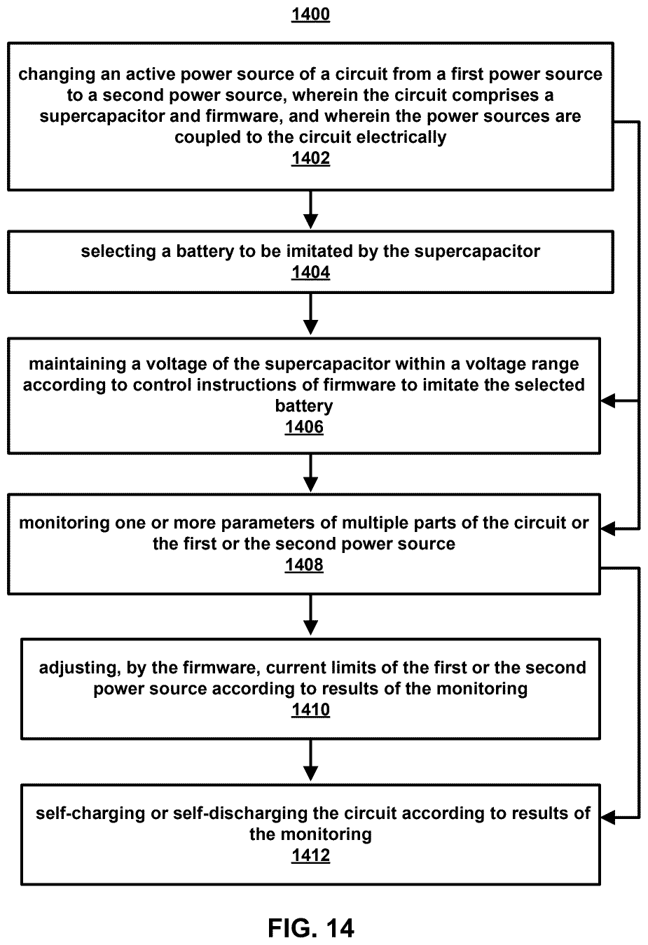

As shown in FIG. 14, a method can include a combination of the features described herein, e.g., see method 1400. As depicted, method 1400 includes, at step 1402, changing an active power source of a circuit from a first power source to a second power source, wherein the circuit includes a supercapacitor and firmware, and wherein the power sources are coupled to the circuit electrically. In some examples, the method can include enabling or disabling the active power source of a circuit from the first power source to the second power source. The method 1400 also includes, at step 1404, selecting a battery to be imitated by the supercapacitor. At step 1406, the method includes maintaining a voltage of the supercapacitor within a voltage range according to control instructions of firmware to imitate the selected battery. At step 1408, the method includes monitoring one or more parameters of multiple parts of the circuit or the first or the second power source. At step 1410, the method includes adjusting, by the firmware, current limits of the first or the second power source according to results of the monitoring. At step 1412, the method includes self-charging or self-discharging the circuit according to results of the monitoring.

In some embodiments, the methods and systems described herein can be implemented through or with improved battery banks or power circuits. Also, such systems can combine a high energy-density energy storage device and a high power-density energy storage device into a single device through programmable power conversion. In some embodiments, the programmable hybrid battery bank combines multiple unique energy storage technologies into a single integrated device. In such embodiments, the programmable hybrid battery bank provides an improved energy storage solution over known battery banks. The programmable hybrid battery bank provides a wider range of battery options for a given application by mitigating common performance and safety constraints such as discharge rate, cycle life, etc. Integrated programmable power electronics included with the bank provide better monitoring and control capability. And, the bank provides a model for constructing larger energy storage systems with a simplified modular approach.

In some embodiments, the programmable hybrid battery bank (e.g., see programmable hybrid battery banks 1500 and 1600 shown in FIGS. 15 and 16) combines a high energy-density energy storage device and high power-density energy storage device into a single device through programmable power conversion. As shown in the embodiment of bank 1500 illustrated in FIG. 15, a load 1502 is connected to positive and negative output terminals, which are directly connected to an energy storage device with a high power density, in this case, a supercapacitor 1504. The supercapacitor is labeled as a “SCAP” in the FIG. 15. In some embodiments, the supercapacitor includes a single cell or multiple cells combined in series or in parallel configurations.

In the embodiment shown in FIG. 15, of which there are many alternatives, use of the supercapacitor provides numerous advantages over a battery including high surge power capability, high cycle life, variable voltage capability, protection against thermal runaway, etc. Charging and discharging of battery 1506 is controlled by built-in power electronics, such as the programmable power electronics 1508 shown in FIG. 15.

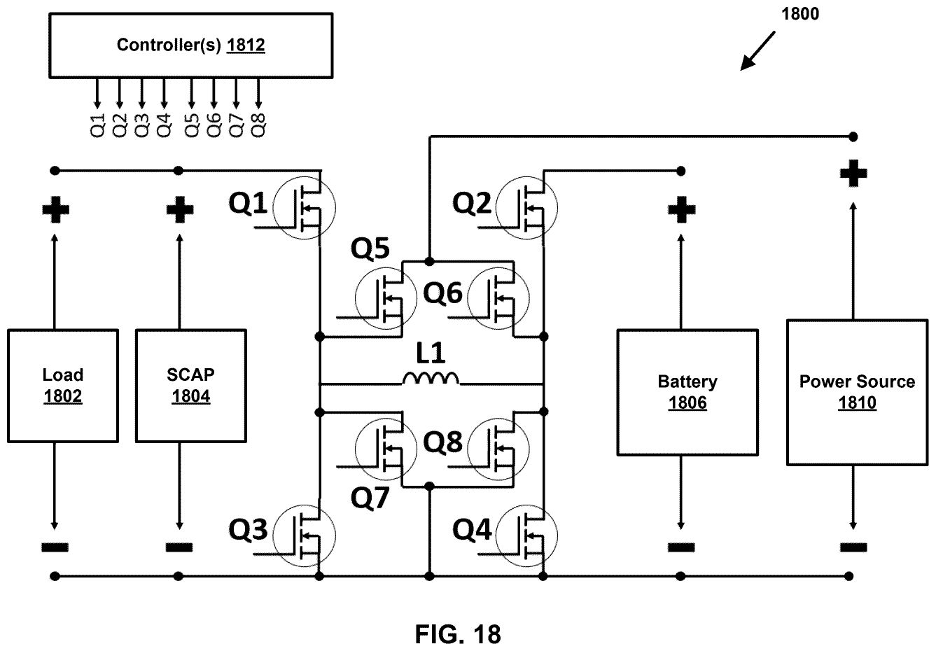

In the embodiment shown in FIG. 15, the battery 1506 and supercapacitor 1504 can operate at different or similar voltages, and power is converted between these two components by the built-in power electronics, shown as programmable power electronics 1508 in FIG. 15. In some embodiments, power is converted between the components using a DC-DC buck-boost converter in the power electronics, which can be multi-directional (e.g., see the buck-boost converters 1700, 1800, 1900, and 2000 shown in FIGS. 17 to 20 respectively). In other words, in such examples, the built-in power electronics shown as programmable power electronics 1508 include a DC-DC buck-boost converter. An example of a bidirectional buck-boost converter 1700 that can implement a power conversion in the built-in power electronics is shown in FIG. 17. Examples of multi-directional buck-boost converters, beyond two directions, which can implement the power conversions in the built-in power electronics are shown in FIGS. 18, 19 and 20 (e.g., see converters 1800, 1900, and 2000).

The power electronics operation, e.g., whether it is the power electronics shown in FIG. 15 or 16, is customizable through circuit design or software and is driven by a logic controller that can monitor various internal and external parameters (e.g., voltages, temperatures, external commands, etc.). The charge state of the system (such as the system shown in FIG. 15 or 16) is determined by a combination of monitored voltages and other parameters, and the power electronics are programmed to a default behavior based on the charge state or other monitored parameters, which can be reprogrammed or monitored or modified in real-time. Such functionality can be implemented through the programmable power electronics 1508 shown in FIG. 15 or the programmable power electronics 1608a, 1608b, and 1608c shown in FIG. 16.

The loads of each bank, e.g., see loads 1502 and 1602, as well as one or more optional power sources such as one or more charging voltage sources (e.g., see optional power sources 1510 and 1610a, 1610b, and 1610c) or additional loads can also be connected through the power electronics. In some embodiments, power can be transferred in multiple directions when using a multi-directional DC-DC buck boost converter (e.g., see converter 1800 shown in FIG. 18) as a converter having a battery to supercapacitor direction, supercapacitor to battery direction, power source(s) to supercapacitor direction, power source(s) to battery direction, supercapacitor to power source(s) direction, battery to power source(s) direction, between different power sources direction, etc.). In such embodiments, the power source(s) can include or be one or more charging sources. Additional converter directions as shown in FIGS. 18, 19, and 20 enable numerous possible configurations including secondary backup functionality for a particular power source (such as a particular charging source), or the ability to add on additional energy storage. As an example, the purpose of this can be to add secondary batteries for additional energy, including different types of batteries with different performance features. Another example would be to store power from an intermittent power source when it is available, such as from a solar panel.

Large battery systems including smaller batteries connected in series or parallel are used for a wide variety of applications. These include motive applications, large backup power systems, grid-scale energy storage, renewable energy storage, and many other applications. Batteries in the aforementioned applications should be closely monitored and controlled for optimal performance and safety. Depending on the chemistry, this usually includes cell balancing and closely managed charge and discharge performance. Even sophisticated system designs fail, leading to premature battery life and potentially dangerous thermal runaway conditions.

Multiple programmable hybrid power batteries can also be connected in series or parallel for larger energy storage needs, offering several advantages over comparable single-technology installations. The hybrid design of programmable hybrid battery bank 1500 shown in FIG. 15, includes a supercapacitor (labeled “SCAP 1504”) and a battery (labeled “Battery 1506”). In some embodiments, the hybrid design can be replicated to form a design with multiple supercapacitors and batteries, e.g., see programmable hybrid battery bank 1600 shown in FIG. 16. In FIG. 16, each supercapacitor is labeled “SCAP” and each battery being labeled “Battery”, e.g., see SCAPs 1604a, 1604b, and 1604c and batteries 1606a, 1606b, and 1606c. In these embodiments, supercapacitors can be much more resilient while also providing significantly higher power density.

As shown in FIG. 16, the hybrid design of the programmable hybrid battery bank 1600 includes supercapacitors and batteries and are connected in series (e.g., see SCAPs 1604a, 1604b, and 1604c and batteries 1606a, 1606b, and 1606c). This allows the supercapacitors to act as a power buffer to improve system power, life, and safety. The batteries are subject to reduced short-term power requirements with fully programmable charge and discharge rates to ensure safer operations. Balancing of the battery cells is eased and becomes self-contained at a modular level. Each battery is separated from the others through the power electronics of each module, which independently manage battery health per defined parameters.

In some embodiments, such as the embodiment shown in FIG. 16, the independent operation and control of each module (including a supercapacitor, a separate programmable power electronics, a battery, and optional power source(s) that can include one or more optional charging sources) introduces the capability for multiple layers of automated or semi-automated decentralized control, simplifying integration requirements for larger installations, reducing control complexity, and improving overall system performance. Detailed monitoring at the module level allows for the quick identification of anomalies, providing multiple levels of visibility for safety and oversight. In these installations each module can be connected to an isolated power source (such as an isolated charging source) to ensure that potential imbalances between modules are self-corrected, and charging parameters are adjustable to optimize performance. Serviceability is also improved, as individual battery modules can safely be serviced or replaced with little or no impact on the larger system.

Turning to FIGS. 17 to 20, shown are converters 1700, 1800, 1900, and 2000, that can be integrated with the programmable power electronics 1508 and 1608a to 1608c shown in FIGS. 1 and 16, respectively. Specifically, FIG. 17 illustrates a system including a bidirectional buck-boost converter 1700. For another example of a bidirectional buck boost converter, see U.S. Pat. No. 5,734,258A. Some embodiments extend the bidirectional buck-boost converter to compensate for multiple loads or for multiple power sources (such as three or more power sources or loads).

FIG. 18 shows the topology of the bidirectional buck-boost converter extended into hex directional buck-boost converter 1800. In some embodiments, a system includes a circuit design approach that extends a bidirectional buck-boost converter to three or more power sources or loads. Extending bidirectional conversion technology from two sources to three expands the integration possibilities of various energy storage technologies and other DC power systems. For instance, it allows multiple energy storage technologies to be integrated together with another power source or load. With such embodiments, high power technology can be paired with high energy technology to provide an energy storage device that has improved combined power and energy performance for a given application. The power and energy performance is improved to an extent that oversizing battery energy capacity for the sake of increasing short-term power capability is not needed. Also, safety, cost, life, and other considerations are improved in such embodiments.

In some embodiments, a system includes and integrates a supercapacitor and a battery. Batteries provide high energy density, but are often constrained in power, cycle life, safety, cost, and other factors. These tradeoffs vary with the type of battery selected. Supercapacitors, on the other hand, have lower energy density than batteries but tend to outperform batteries in the other mentioned areas. A system with a battery and a supercapacitor can allow for adjusting the system to obtain a determined balance of such factors (e.g., factors including power output, cycle life, safety, and cost constraints). In some embodiments, active power conversion is used to integrate a battery and a supercapacitor, as supercapacitors and batteries have different operating voltage profiles—which could also be different from the power source voltage, or more specifically, a charging source voltage. E.g., see power source 1810 shown in FIG. 18.

The hex directional buck-boost converter 1800 shown in FIG. 18 includes a load 1802, a supercapacitor 1804, a battery 1806, and a power source 1810 (which can be a separate power source). The hex directional buck-boost converter 1800 uses a multi-directional buck-boost conversion circuit for charging and internal power transfers. The hex directional buck-boost converter 1800 can provide improved system performance over using either supercapacitor 1804 or battery 1806 separately. Such a circuit also breaks the direct connection between the battery 1806 and the load 1802. This allows some embodiments to include logic control of the battery charging and discharging to further adjust performance and safety factors provided by the system (e.g., see the one or more controllers shown in FIG. 18 and labeled as “Controller(s) 1812”.). As shown in FIG. 18, the one or more controllers 1812 can control the output of each of the field effect transistors (FETs) of the system (e.g., see the controller(s) labeled “Controller(s)” and the FETs labeled “Q1”, “Q2”, “Q3”, “Q4”, “Q5”, “Q6”, “Q7”, and “Q8”). As shown in FIG. 18 as well as FIGS. 17, 19, 20, 22, and 23, the FETs are n-type FETs. However, it is to be understood that in some other embodiments the FETs can be p-type FETs or a combination of n-type and p-type FETs.

It is to be understood that the system shown in FIG. 18 can be altered for different applications and power conversion functionality. As shown, and as in embodiments related to the system shown in FIG. 18, the system includes one or two field effect transistors (FETs) directly upstream of an inductor (e.g., see the inductor labeled “L1” and the FETs labeled “Q5” and “Q6” shown in FIG. 18). Also, shown in FIG. 18 are additional upstream FETs (e.g., see the FETs labeled “Q1” and “Q2”). The directly upstream FETs (such as the FETS labeled “Q5” and “Q6”) and the inductor are integrated in the system such that a power source can be added and used to charge the battery 1806 or the supercapacitor 1804. Also, as shown in FIG. 18, in some embodiments, additional downstream FETs (e.g., see the FETs labeled “Q7” and “Q8”) can be removed when the upstream FETs are properly matched to additional downstream FETs (e.g., see the FETs labeled “Q3” and “Q4”).

In some embodiments, such as the example system shown in FIG. 18 and systems related to the system shown in FIG. 18, six directions of power conversion are possible, each with buck-boost functionality. The directions of power conversion can be controlled by the controller(s) 1812 of the system. The six directions of power conversion include power source 1810 to battery 1806, power source 1810 to supercapacitor 1804 and load 1802, battery 1806 to power source 1810, battery 1806 to supercapacitor 1804 and load 1802, supercapacitor 1804 and load 1802 to battery 1806, and supercapacitor 1804 and load 1802 to power source 1810.

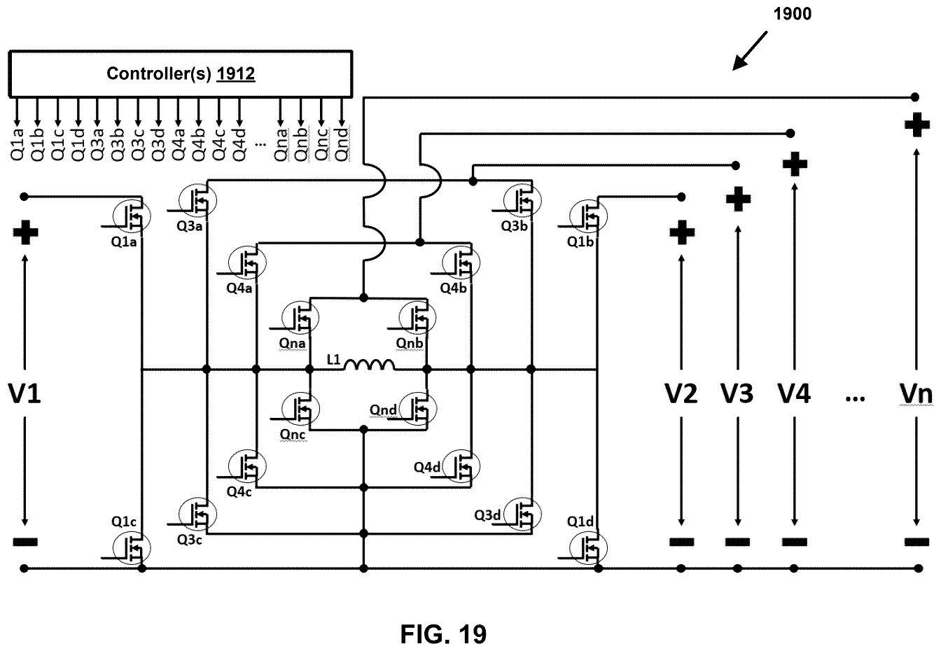

As mentioned, some embodiments extend the bidirectional buck-boost converter to compensate for multiple loads or for multiple power sources (such as three or more power sources or loads). FIG. 19 shows the topology of the bidirectional buck-boost converter extended into a n-source buck-boost converter 1900. In other words, FIG. 19 illustrates the topology of the bidirectional buck-boost converter extended into a buck-boost converter for multiple power sources (such as a number of power sources well beyond three power sources). As shown in FIG. 19, in some embodiments, the possible directions of power transfer can become a factorial of the number of power sources or loads. The system shown in FIG. 19 includes multiple power sources (e.g., see the power sources labeled “V2”, “V3”, “V4”, and “VN”, and the load labeled “V1”). Conversely, a related system can have multiple loads (e.g., when “V2”, “V3”, “V4”, and “VN” are considered loads and “V1” is considered a power source). Also, shown in FIG. 19, controller(s) 1912 control the many different directions of power transfer of the system via control of the FETs of the system (e.g., see FETs labeled “Q1a”, “Q1b”, “Q1c”, “Q1d”, “Q3a”, “Q3b”, “Q3c”, “Q3d”, “Q4a”, “Q4b”, “Q4c”, “Q4d”, “Qna”, “Qnb”, “Qnc”, and “Qnd”).

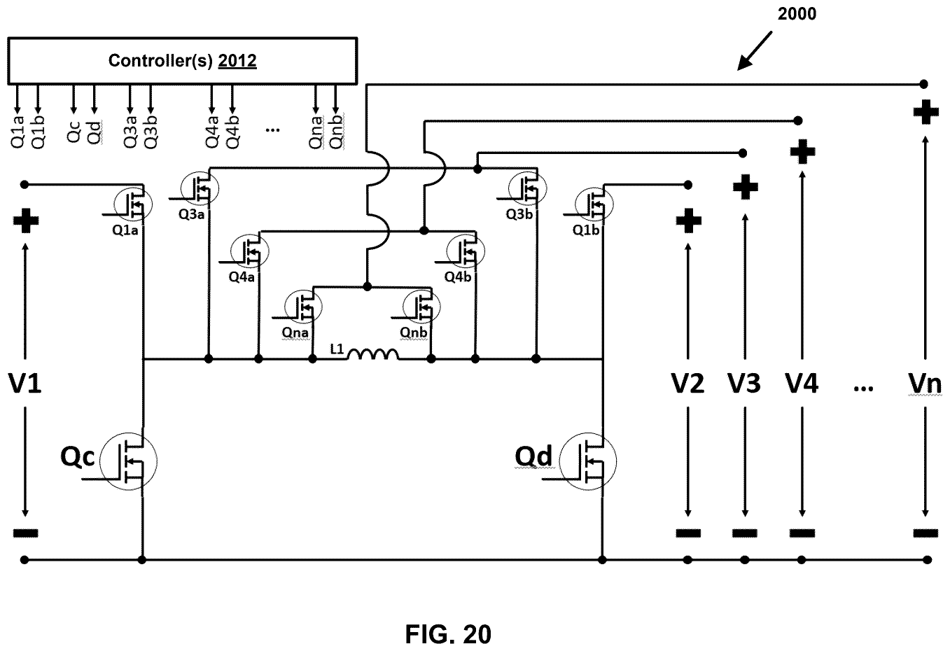

FIG. 20 shows the topology of the bidirectional buck-boost converter extended into an n-source buck-boost converter 2000 that has a reduced number of FETs compared to the converter 1900 shown in FIG. 19. To reduce the number of FETs of the circuit, proper application sizing can combine the lower FETs into as few as two components (as shown in FIG. 20). This reduces circuit complexity. In the system of FIG. 20, the FETs labeled “Q1c”, “Q1d”, “Q3c”, “Q3d”, “Q4c”, “Q4d”, “Qnc”, and “Qnd” have been replaced with two FETs labeled “Qc” and “Qd”. Also, shown in FIG. 20, controller(s) 2012 control the many different directions of power transfer of the system via control of the FETs of the system.

In some embodiments, such as the embodiments shown in FIGS. 19 and 20, a multi-directional buck-boost converter for regulating power flow between two or three or more voltage sources (in which the voltage sources can be power sources, loads, or a combination thereof) can include a bidirectional buck-boost converter between first and second voltage sources of such voltage sources. In some of such examples, two switching devices are connected in series between the positive and negative poles of the first and second voltage sources. Also, in some of such examples, the two switching devices are coupled by an inductor connected to an intermediate junction of the pair of switching devices and other similar pairs of switching devices of the converter. Also, in some of such embodiments, a positive pole of one or more additional voltage sources (in which the additional voltage sources can be power sources, loads, or a combination thereof) can be coupled to one or more junctions of the inductor using switching devices. And, the negative poles of each additional voltage source can be coupled together so that the switching devices can be operated by a controller to conduct current between at least two of the voltage sources of the converter and selected to do so in one of three or more directions. Also, in some of such embodiments and other embodiments (e.g., see FIG. 23), a multi-directional buck-boost converter includes one or more bypass circuits. In such examples, a bypass circuit includes one or more switching devices coupling the positive poles of any two voltage sources (in which the voltage sources can be power sources, loads, or a combination thereof) so that current can be conducted between the two voltage sources without being conducted through the inductor.

Some embodiments of the n-source buck-boost converter offer numerous opportunities to integrate multiple (such as more than two) power sources or loads. Such embodiments can help to advance the use and adoption of energy storage devices, and renewable energy and could improve power electronics integration. Such embodiments can improve the concept of bidirectional power conversion by extending it beyond two directions and two power sources or loads, adding significant new capabilities with a modest increase in complexity.

The embodiments described herein can be adapted to various permutations depending on application needs. For example, some connections can be unidirectional, others can be bidirectional, and yet others can be n-directional (or can be multi-direction in general). This can be accomplished through logic control or modest tweaks to the circuit design by those skilled in the art. The voltage levels can vary across the various devices and voltage sources within the tolerances of the selected components. Relays can be added for ground isolation when appropriate, and numerous other circuit design techniques can be incorporated. Another key capability is that each connection can be logically controlled, enabling opportunities for software or hardware customization and control.

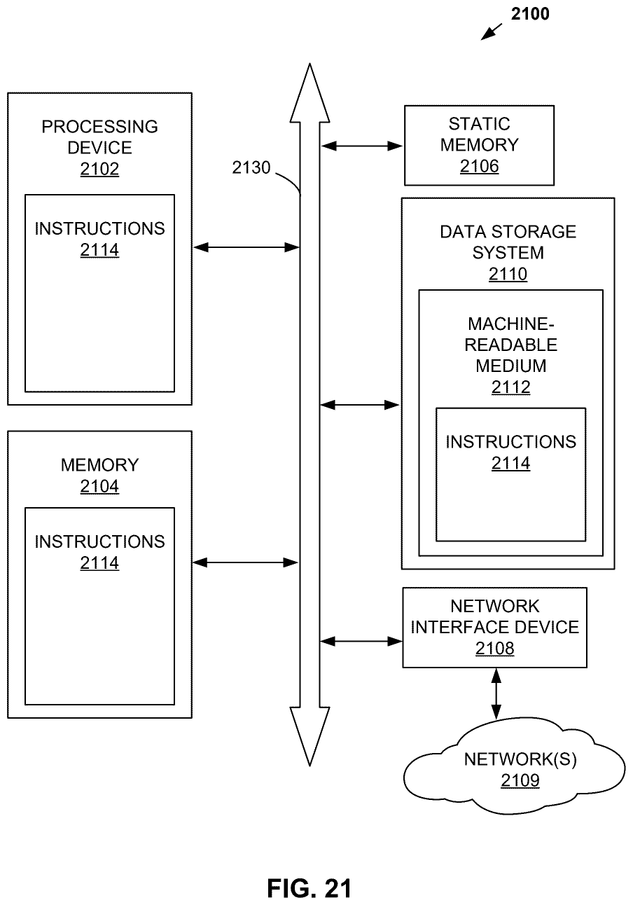

In embodiments with software or hardware customization and control, the system includes a computing device (such as computing device 2100 shown in FIG. 21). For example, the controllers described herein (such as controller(s) 1812, 1912, 2012, 2212, and 2312) can include the computing device 2100. The computing device 2100 includes a processing device 2102, a main memory 2104 (e.g., read-only memory (ROM), flash memory, dynamic random-access memory (DRAM), etc.), a static memory 2106 (e.g., flash memory, static random-access memory (SRAM), etc.), and a data storage system 2110, which communicate with each other via a bus 2130. The processing device 2102 can include one or more general-purpose processing devices such as a microprocessor, a central processing unit, or the like. More particularly, the processing device 2102 can be a microprocessor or a processor implementing other instruction sets, or processors implementing a combination of instruction sets. The processing device 2102 can also include one or more special-purpose processing devices such as an application specific integrated circuit (ASIC), a field programmable gate array (FPGA), a digital signal processor (DSP), a network processor, or the like. The processing device 2102 can be configured to execute instructions 2114 for performing the operations discussed herein. Such a computer system can further include a network interface device 2108 to communicate over LAN/WAN network(s) 2109. The data storage system 2110 can include a machine-readable storage medium 2112 (also known as a computer-readable medium) on which is stored one or more sets of instructions (such as instructions 2114) or software embodying any one or more of the methodologies or functions described herein. The instructions 2114 can also reside, completely or at least partially, within the main memory 2104 or within the processing device 2102 during execution thereof by the computer system, the main memory and the processing device also constituting machine-readable storage media.

While the machine-readable storage medium 2112 can be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

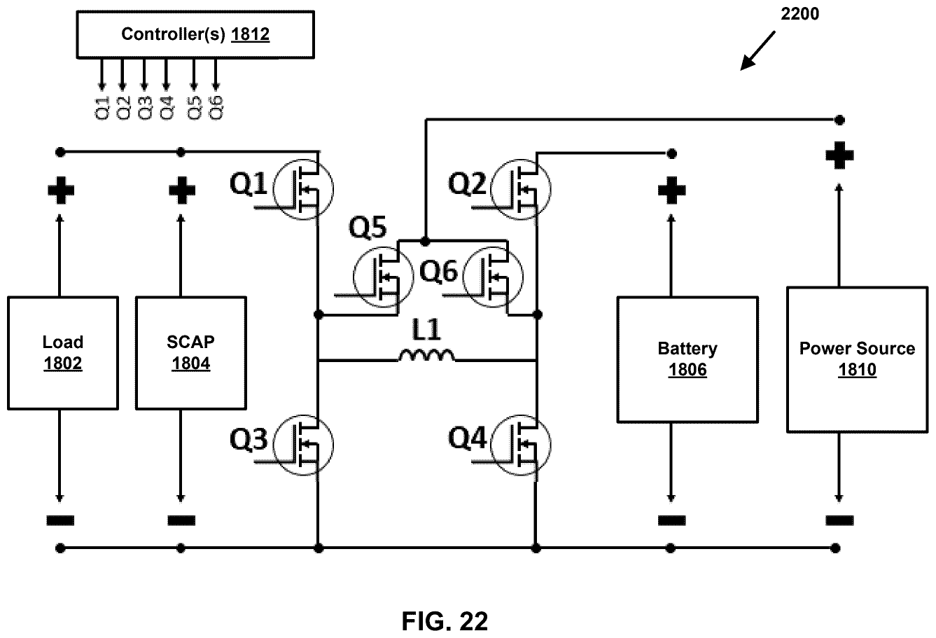

In some embodiments, two or more of the power sources or loads may operate at or near the same voltage during periods of operation (e.g., see FIGS. 22 and 23). When this is the case, it may be beneficial to temporarily bypass the buck-boost converter circuit. There can be multiple benefits in bypassing the buck-boost converter in this manner. For example, bypassing the converter eliminates heat losses from the power conversion process. Also, bypassing the buck-boost converter may allow the buck-boost controller to be temporarily turned off or put into low power mode, further reducing parasitic losses. And, directly connecting two or more sources or loads in this manner allows for another source or load to simultaneously charge or discharge the connected sources or loads through the buck-boost converter. Thus, in some embodiments of the systems described herein, the converter includes or is connected to a bypass circuit and the multiple power sources or loads of similar voltage can be directly connected by the bypass circuit to avoid use of the converter.

FIG. 22 illustrates another system including a hex-directional buck-boost converter 2200. In this example embodiment there is no bypass circuit. FIG. 22 shows the topology of the hex-directional buck-boost converter that has a reduced number of FETs compared to the converter shown in FIG. 18. And, to reduce the number of FETs of the circuit, proper application sizing can combine the lower FETs into as few as two components (as shown in FIG. 22). This reduces circuit complexity. In the system of FIG. 22, the FETs labeled “Q7” and “Q8” have been removed to reduce circuit complexity. Similar to converter 1800, converter 2200 includes load 1802, supercapacitor 1804, battery 1806, and power source 1810. With the reduced circuit complexity, the controller 2212 of the converter 2200 also has reduced complexity relative to controller(s) 1812 of converter 1800.

FIG. 23 illustrates another system including a hex-directional buck-boost converter 2300 as well as a bypass circuit 2320. FIG. 23 shows the topology of the hex-directional buck-boost converter 2300 that has a reduced number of FETs compared to the converter shown in FIG. 18 (similar to the converter shown in FIG. 22). And, FIG. 23 shows how the FETs labeled “Q7” and “Q8” can be moved in the converter to implement a bypass circuit 2320. Also, similar to converter 1800, converter 2300 includes load 1802, supercapacitor 1804, battery 1806, and power source 1810. The converter 2300 also includes the controller 2312 of the converter 2200 that controls the FETs of the converter 2300 and the bypass circuit 2320.

In the example converter 2300 shown in FIG. 23, a bypass circuit 2320 including the FETs labeled “Q7” and “Q8” is located between the positive voltage terminals of supercapacitor 1804. And, in such an arrangement, battery 1806 can be engaged by the system when the supercapacitor 1804 and the battery 1806 equalize in voltage and meet other selected criteria (e.g., discharge rate). The battery 1806 can then directly power the load 1802 connected to the supercapacitor 1804 without incurring buck-boost conversion losses. Further, another available voltage source, such as source 1810, can be used by the buck-boost converter to simultaneously charge both the supercapacitor 1804 and the battery 1806 without disconnecting the battery 1806 from the load 1802.

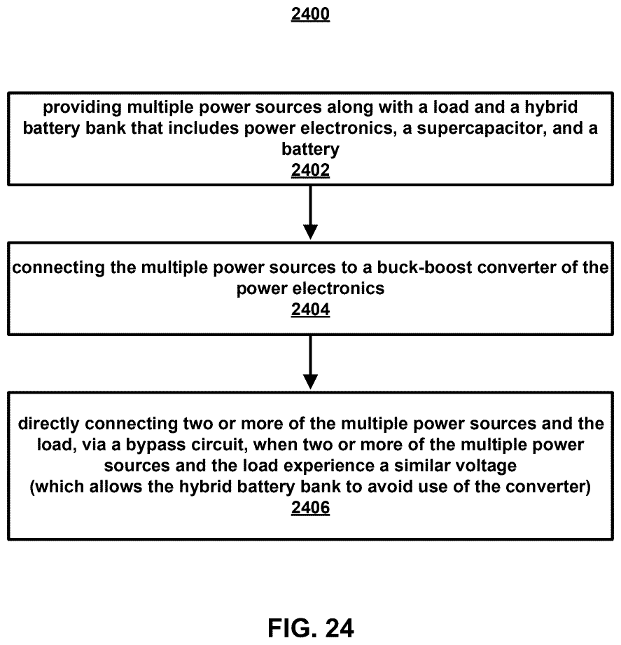

FIG. 24 illustrates a method 2400 in accordance with some embodiments of the present disclosure. The method 2400 commences with step 2402 that includes providing multiple power sources along with a load and a hybrid battery bank that includes power electronics, a supercapacitor, and a battery. The power electronics include a buck-boost converter that is a multi-directional buck-boost converter. At step 2404, the method 2400 continues with connecting the multiple power sources to the buck-boost converter. At step 2406, the method 2400 continues with directly connecting two or more of the multiple power sources and the load, via a bypass circuit, when two or more of the multiple power sources and the load experience a similar voltage. The connection to the bypass circuit allows the hybrid battery bank to avoid use of the converter when the two or more of the multiple power sources and the load experience a similar voltage or to use the converter to simultaneously charge the supercapacitor and the battery without disconnecting the battery from the load.

Referring back to more general examples, in some exemplary embodiments, a system includes a load and a hybrid battery bank. And, the hybrid battery bank includes power electronics, a supercapacitor, and a battery (e.g., see loads 1502, 1602, and 1802 and SCAPs 1504, 1604a, and 1804 as well as batteries 1506, 1606a, and 1806). In some of such exemplary embodiments, the system also includes a plurality of hybrid battery banks connected in a series arrangement. Also, in some of such exemplary embodiments, the system includes a plurality of hybrid battery banks connected in a parallel arrangement. Also, in some of such exemplary embodiments, the load, the supercapacitor, and the battery are connected to each other through a power conversion circuit. Also, in some of such exemplary embodiments, the system includes additional supercapacitors, additional programmable power electronics, and additional batteries (e.g., see the optional power sources 1510, 1610a, 1810, V2, and VN)).

With examples including the additional supercapacitors, the additional programmable power electronics, and the additional batteries, the system can further include a plurality of modules, wherein each module includes at least one supercapacitor of the system, at least one set of programmable power electronics of the system, at least one battery of the system. Furthermore, in some of such examples, each battery is separated from other batteries through a respective set of power electronics of each module, and wherein each one of the power electronics of each module independently manages battery operation per defined parameters.

In some of the exemplary embodiments, the power electronics include a buck-boost converter (e.g., see buck-boost converters 1700, 1800, and 1900). In some of the examples including the buck-boost converter, the buck-boost converter is a multi-directional buck-boost converter. For example, in some instances, the buck-boost converter is a bidirectional buck-boost converter (e.g., see converter 1700). Or, for example, in some other instances, the buck-boost converter is a multi-directional buck-boost converter having three or more directions of conversion (e.g., see converter 1800). Also, in some of the examples including the buck-boost converter, the system further includes multiple power sources connected to the converter (e.g., see converter 1900). For example, in some instances, the multiple power sources include at least three power sources. Also, in some of the examples including the buck-boost converter, the system further includes multiple power sources, which are parts of the converter.

In some exemplary embodiments, a system includes a load and a hybrid battery bank, wherein the bank includes a buck-boost converter, a supercapacitor, a battery, and one or more optional power sources (e.g., see loads 1502, 1602, and 1802 and SCAPs 1504, 1604a, and 1804 as well as batteries 1506, 1606a, and 1806 as well as see the optional power sources 1510, 1610a, 1810, V2, and VN). In some of such examples, the buck-boost converter is a multi-directional buck-boost converter. And, in some of such instances with the multi-directional buck-boost converter, the buck-boost converter is a bidirectional buck-boost converter. Also, in some of such instances with the multi-directional buck-boost converter, the buck-boost converter is a multi-directional buck-boost converter having three or more directions of conversion (e.g., see buck-boost converters 1700 and 1800).

In some exemplary embodiments, a system includes multiple loads and a hybrid battery bank that includes programmable power electronics, a supercapacitor, a battery, and one or more optional power sources (e.g., see the respective systems depicted in FIGS. 15 to 20 and FIGS. 22 and 23 ) . In some of such examples, the system further includes multiple power sources, and the multiple power sources include at least three power sources, and the multiple loads include at least three loads. Also, in some of such examples, the multiple power sources and the multiple loads are part of a buck-boost converter that is a part of the programmable power electronics. Also, in some of such examples, the multiple power sources and the multiple loads are part of the programmable power electronics. Furthermore, in some embodiments of the system, the converter includes or is connected to a bypass circuit (e.g., see bypass circuit 2320) and when two or more of the multiple power sources or loads experience a similar voltage, such components can be directly connected by the bypass circuit.

In some exemplary embodiments, a system includes a load and a hybrid battery bank that includes power electronics, a supercapacitor, a battery, and one or any combination of an optional power source (e.g., an optional charging source) and a load. In some of such examples, the system further includes one or any combination of a plurality of power sources (e.g., a plurality of optional charging sources) and a plurality of loads. Also, in such examples, the load, the supercapacitor, the battery, and the one or any combination of an optional power source (e.g., an optional charging source) and a load can be connected to each other through a power conversion circuit. In some examples with the power conversion circuit, the power conversion circuit is implemented using programmable power electronics. Furthermore, in some embodiments of the system, the power conversion circuit includes or is connected to a bypass circuit and when two or more of the power sources or loads experience a similar voltage, such components can be directly connected by the bypass circuit.

In some exemplary embodiments, a system includes a buck-boost converter and multiple power sources connected to the converter. In some of such exemplary embodiments, the multiple power sources include at least three power sources. And, in some of the aforesaid embodiments, the multiple power sources are part of the converter. Also, in some of such exemplary embodiments, the multiple power sources are part of the converter.

In some exemplary embodiments, a system includes a buck-boost converter and multiple loads connected to the converter. In some of such exemplary embodiments, the multiple loads include at least three loads. And, in some of the embodiments, the multiple loads are part of the converter whether or not the multiple loads include at least three loads. Furthermore, in some embodiments of the system, the converter includes or is connected to a bypass circuit and when two or more of the multiple loads experience a similar voltage, such components can be directly connected by the bypass circuit.

In some exemplary embodiments, a system includes a buck-boost converter and multiple power sources connected to the converter as well as multiple loads connected to the converter. In some of such exemplary embodiments, the multiple power sources include at least three power sources, and wherein the multiple loads include at least three loads. And, in some of the embodiments, the multiple power sources and the multiple loads are part of the converter. Also, in some of the examples, the multiple power sources and the multiple loads are part of the converter. Furthermore, in some embodiments of the system, the converter includes or is connected to a bypass circuit and when two or more of the multiple power sources or loads experience a similar voltage, such components can be directly connected by the bypass circuit.

In some examples, the systems can include multi-directional buck-boost converter topologies (e.g., hex-directional and n-source) with controller-coordinated switching and optional bypass path. This can include architectures extending bidirectional buck-boost to ≥3 sources or loads with shared inductor and controlled FET networks, factorial routing, reduced-FET variants, and bypass circuit that directly couples sources at similar voltage to avoid conversion loss. Such hardware or topology can be independent of the control methods described herein.

In some examples, the systems can include a modular programmable hybrid battery bank architecture (e.g., each module having SCAP, battery, converter, controller, and optional energy sources.) with series or parallel scaling and decentralized control. The module-level power electronics can separate each battery from others via DC-DC conversion;, use a supercapacitor as power buffer, provide improved safety, balancing, serviceability, and system-level series or parallel arrays with independent monitoring and control can be provided. Such systems can provide a system-level architecture and interconnection strategy.

Specifically, in some embodiments, a hybrid energy storage system can include a supercapacitor subsystem, a battery subsystem, and at least one DC-DC converter that is bi-directional or multi-directional, and coupled to the supercapacitor subsystem, the battery subsystem, and at least one external power source or load. Such a system can also include sensors configured to measure voltage, current, and temperature at plural points including converter input or output and a bypass path. And, such a system can include a controller executing prioritization logic configured to perform any one of the functions described herein. For example, the controller can execute prioritization logic configured to monitor the measurements in real time, categorize sources or sinks as high, low, or out-of-spec relative to stored thresholds with hysteresis, and select an active power flow path and direction via the converter, based on source type flags (e.g., based on input-only/output-only flags), user-defined priorities, setpoints, and state variables. Also, the controller can execute prioritization logic configured to adjust converter current or switching frequency based on inter-source voltage differences and source limits, and to selectively actuate a bypass circuit to directly couple sources when voltages are within a bypass window, and disengage on faults. Such a system can include priority overridden by safety constraints, temperature derating tables, SOC estimation inputs, and external UI configuration (e.g., using Bluetooth, USB, CAN, etc.). Such a system can include different profiles for input-only versus bidirectional sources. And, such a system can include fault logging and messaging.

Specifically, in some embodiments, an energy storage system can include a supercapacitor bank, a converter coupled to the supercapacitor bank and at least one power source or load, and a controller configured to maintain the supercapacitor voltage according to a firmware-controlled virtual voltage profile that emulates a selected battery chemistry or a custom profile. The profile can define at least a maximum voltage, minimum voltage, and temperature-dependent target voltage behavior, and the controller can modulate converter operation to cause the supercapacitor terminal voltage presented to the load to follow the profile across varying load conditions. In some examples, the system can include lookup-tables or algorithmic profiles and linear or constant-power or voltage-stabilized variants. And, in some examples, the system can include external command to switch profiles and profile parameters tuned by load status or external charger behavior (e.g., CC, CV, or float).

Specifically, in some embodiments, a method for adaptive source current-limit control in a hybrid energy storage system, includes continuously monitoring source or converter input voltage. And, the method can include upon detecting a drop below a minimum threshold, automatically reducing a maximum allowable current and a current ramp rate for that source below an instantaneous current as well as disabling or restarting conversion as needed. Also, the method can include gradually increasing current under a primary ramp, with a secondary slower ramp near a percentage of the new limit. The method can also include logging voltage drop events and adjusting future limits and ramp rates based on frequency and recency of events, as well as imposing temperature-based derating with hysteresis. In such a method, embodiments can include DAC or PWM implementations as well as thresholds per source type, auto-disable after N events, or communication of faults.

Specifically, in some embodiments, an energy storage device includes a supercapacitor subsystem, a battery subsystem, a converter coupling the subsystems and external terminals, a voltage probe input configured to sense an external voltage, and a controller configured to perform self-charge and self-discharge operations. For example, the device via the controller can, in response to a command or activation event, automatically charge the supercapacitor to a user-defined or probe-measured target voltage. It can also perform self-discharge by transferring energy into the battery or by dissipating through resistive elements to a storage voltage. And, the device via the controller can manage activation and sleep modes including wake-and-charge to a preset setpoint. In some examples, the system can provide discharge time windows, heat management during resistive discharge, safety interlocks, UI elements and wireless or wired control.

Specifically, in some embodiments, a multi-directional buck-boost converter includes first, second, and third voltage ports respectively coupled to a load, supercapacitor, or battery (or in general to plurality of voltage sources or loads). The converter can also include a shared inductor connected between intermediate junctions of at least two series-connected switching device pairs. The converter can further include switching networks arranged to couple any two of the ports through the inductor for buck-boost energy transfer in either direction. It can also include a controller configured to operate the switching devices to conduct current among the ports in at least six directions. And, in some cases, it can include a bypass switching path configured to directly connect two ports when their voltages are within a threshold, bypassing the inductor. In some examples, an apparatus having a n-source topology, wherein N ports (N≥3), with shared inductor and switching device matrix. Also, such a converter can include reduced-FET embodiments combining common lower devices. And, the controller can orchestrate factorial routing among ports in some examples. In some examples, the converter can include specific FET placements (e.g., see Q1-Q8) and shared lower-leg consolidation. It can also include diode arrangements, gate drive isolation, protection components, and controller sensing points.

Specifically, in some embodiments, a modular hybrid battery bank system includes a plurality of modules connected in series or parallel, each module including at least a supercapacitor, a battery, a programmable power electronics unit including a DC-DC converter coupling the supercapacitor and battery and external terminals, and a module controller configured to independently manage module charge or discharge, temperature limits, balancing, and fault isolation. Each module's power electronics can electrically isolate its battery from other modules during operation, and the supercapacitor acts as a power buffer to reduce battery short-term power stress, improving safety, cycle life, and serviceability. In some embodiments, the system can include module-level isolated chargers, decentralized control layers, hot-swap or service features, series string imbalance self-correction, communications bus, or any combination thereof.

In some examples, the systems can include a computing device and software aspects implementing any of the control methods described herein (e.g., SoC estimation, profile selection, priority logic, adaptive limits, event logging or faulting, etc.). Such systems can include a processor, memory, and instructions that when executed perform any of the methods described herein executable through a computing device.

Specifically, in some embodiments, a non-transitory computer-readable medium storing instructions that, when executed by one or more processors of a hybrid energy storage device, cause the device to perform any of the prioritization methods described herein. It can also cause the device to implement the virtual voltage profiles and process thereof or related to the profiles. It can also cause the device to execute the adaptive current-limit correction processes described herein. It can also cause the device to carry out the self-charging or discharging methods described herein. It can also cause the device to provide such operations and methods along with using event logging, hysteresis, profile switching, UI configuration, and networked communications.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a predetermined selected result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and functionality presented herein are not inherently related to any particular computer or other apparatus. Various general-purpose systems can be used with programs in accordance with the teachings herein, or it can prove convenient to construct a more specialized apparatus to perform the methods described herein. The structure for a variety of these systems will appear as set forth herein. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense. Unless a particular sequence is expressly required, the methods, steps, functions, and operations described herein can be performed in any suitable order. Steps can be added, omitted, repeated, combined, or carried out in parallel or in succession, and such variations fall within the scope of the present disclosure. For example, individual method steps described in connection with one embodiment can be incorporated into other embodiments unless otherwise specified. Likewise, the features, elements, and operations of any embodiment can be used in combination with those of any other embodiment, except where such combinations would be inconsistent or would render the corresponding system hazardous or inoperable.

What is claimed is:

1. A system, comprising:
a supercapacitor;
a battery;
multiple additional energy sources comprising one or more supercapacitors, one or more batteries, or a combination thereof; and
a control circuit, comprising the supercapacitor and firmware, and configured to:
prioritize power transfers between the multiple additional energy sources in a prioritization process for controlling power transfers in the system that utilizes the supercapacitor and the battery;
change an active power source of the system from a first power source to a second power source in the prioritization of the power transfers, wherein the first power source and the second power source are coupled to the control circuit electrically;
select a battery of the system to be imitated by the supercapacitor of the control circuit and maintain a voltage of the supercapacitor within a voltage range according to control instructions of the firmware to imitate the selected battery;
monitor one or more parameters of the first power source or the second power source, wherein the monitored one or more parameters comprises voltage, current, or temperature;
adjust, by the firmware, current limits of the first power source or the second power source according to results of the monitoring of the one or more parameters; and
self-charge or self-discharge according to the results of the monitoring of the one or more parameters.

2. The system of claim 1, further comprising a DC-to-DC converter.

3. The system of claim 2, further comprising a bypass circuit configured to temporarily bypass the DC-to-DC converter.

4. The system of claim 2, wherein the DC-to-DC converter is bidirectional.

5. The system of claim 2, wherein the control circuit is further configured to control the DC-to-DC converter according to the control instructions of the firmware.

6. The system of claim 5, wherein the control of the DC-to-DC converter comprises the maintenance of the voltage of the supercapacitor.

7. The system of claim 6, further comprising a bypass circuit configured to temporarily bypass the DC-to-DC converter, wherein the maintenance of the voltage of the supercapacitor comprises switching current from the converter to the bypass circuit.

8. The system of claim 7, wherein the supercapacitor and the first power source are connected by the bypass circuit, and the DC-to-DC converter maintains the combined voltage of the supercapacitor and the first power source using the second power source.

9. The system of claim 1, wherein the changing of the active power source occurs according to the monitored one or more parameters.

10. The system of claim 1, wherein the maintaining of the voltage of the supercapacitor occurs according to the monitored one or more parameters.

11. The system of claim 1, wherein the instructions of the firmware are modifiable via a user interface.

12. A method, comprising:
in a prioritization process for controlling power transfers in a hybrid energy storage system that utilizes at least one supercapacitor and at least one battery, prioritizing power transfers between multiple energy sources of the system using a control circuit, wherein the prioritizing of the power transfers comprises changing, via the control circuit, an active power source of the system from a first power source to a second power source, and wherein the control circuit comprises a supercapacitor and firmware, and wherein the first power source and the second power source are coupled to the control circuit electrically;
selecting a battery of the system to be imitated by the supercapacitor of the control circuit and maintaining a voltage of the supercapacitor within a voltage range according to control instructions of the firmware to imitate the selected battery;
monitoring one or more parameters of the first power source or the second power source, wherein the monitored one or more parameters comprises voltage, current, or temperature;
adjusting, by the firmware, current limits of the first power source or the second power source according to results of the monitoring of the one or more parameters; and
self-charging or self-discharging the control circuit according to results of the monitoring of the one or more parameters.

13. The method of claim 12, further comprising the control circuit controlling a DC-to-DC converter of the system according to the control instructions of the firmware.

14. The method of claim 13, further comprising a bypass circuit of the system temporarily bypassing the DC-to-DC converter.

15. The method of claim 14, wherein the controlling of the DC-to-DC converter comprises the maintenance of the voltage of the supercapacitor.

16. The method of claim 15, wherein the maintenance of the voltage of the supercapacitor comprises switching current from the converter to the bypass circuit.

17. The method of claim 14, further comprising:
the bypass circuit connecting the supercapacitor and the first power source; and
the DC-to-DC converter maintaining the combined voltage of the supercapacitor and the first power source using the second power source.

18. The method of claim 12, wherein the changing of the active power source occurs according to the monitored one or more parameters.

19. The method of claim 12, wherein the maintaining of the voltage of the supercapacitor occurs according to the monitored one or more parameters.

20. A non-transitory computer-readable medium storing instructions that when executed cause a computing device to:
in a prioritization process for controlling power transfers in a hybrid energy storage system that utilizes at least one supercapacitor and at least one battery, prioritize power transfers between multiple energy sources of the system using a control circuit, wherein the prioritizing of the power transfers comprises changing, via the control circuit, an active power source of the system from a first power source to a second power source, and wherein the control circuit comprises a supercapacitor, and wherein the first power source and the second power source are coupled to the control circuit electrically;
select a battery of the system to be imitated by the supercapacitor of the control circuit and maintain a voltage of the supercapacitor within a voltage range to imitate the selected battery;
monitor one or more parameters of the first power source or the second power source;
adjust current limits of the first power source or the second power source according to results of the monitoring of the one or more parameters; and
charge or discharging the control circuit according to results of the monitoring of the one or more parameters.
